(19) United States
(12) Patent Application Publication
(10) Pub. No.: US 2024/0288841 A1
(43) Pub. Date: Aug. 29, 2024

(54) IN-SITU HISTORY IN GRAPH-BASED MODELS

(71) Applicant: INFOSYS LIMITED, Bangalore (IN)

(72) Inventor: Steven Schilders, Columbus, IN (US)

(73) Assignees: INFOSYS LIMITED, Bangalore, KA (IN); INVERTIT INC., Columbus, IN (US)

(21) Appl. No.: 18/583,355

(22) Filed: Feb. 21, 2024

Related U.S. Application Data
(60) Provisional application No. 63/449,224, filed on Mar. 1, 2023.
(60) Provisional application No. 63/448,747, filed on Feb. 28, 2023.
(60) Provisional application No. 63/448,738, filed on Feb. 28, 2023.
(60) Provisional application No. 63/448,861, filed on Feb. 28, 2023.
(60) Provisional application No. 63/448,831, filed on Feb. 28, 2023.

(51) Int. Cl. G05B 15/02

(52) U.S. Cl. CPC G05B 15/02

(57) ABSTRACT

An overlay system is provided that includes a storage element and processing circuitry. The storage element stores an executable graph-based model that includes various active nodes, various history nodes, and various history overlay nodes. Each active node is associated with one or more history nodes and one or more history overlay nodes. The one or more history overlay nodes facilitate the generation and maintenance of one or more history nodes (e.g., one or more historical versions of the corresponding active node). The processing circuitry receives a contextualized stimulus associated with the overlay system and identifies an active node and one or more associated history nodes, in the executable graph-based model based on the context. The processing circuitry further executes an operation associated with the stimulus based on the identified active node, the associated one or more history overlay nodes, and the identified one or more history nodes.

### CROSS-REFERENCE TO RELATED APPLICATIONS/INCORPORATION BY REFERENCE

This patent application refers to, claims priority to, and claims the benefit of U.S. patent application Ser. No. 63/449,224, filed Mar. 1, 2023, U.S. patent application Ser. No. 63/448,747, filed Feb. 28, 2023, U.S. patent application Ser. No. 63/448,738, filed Feb. 28, 2023, U.S. patent application Ser. No. 63/448,861, filed Feb. 28, 2023, and U.S. patent application Ser. No. 63/448,831, filed Feb. 28, 2023, the contents of which are hereby incorporated herein by reference in their entirety.

### FIELD OF THE DISCLOSURE

Various embodiments of the present disclosure relate generally to graph-based models. More specifically, various embodiments of the present disclosure relate to in-situ history in executable graph-based models.

### BACKGROUND

Advancements in the field of science and engineering have enabled exploration of various domains such as robotics, artificial intelligence, machine learning, or the like, to facilitate digitization and automation of systems associated with various applications (such as healthcare, finance, warehouse, or the like). Storing of data associated with a system and manipulation of the stored data is crucial for the digitization and automation of the corresponding system. Such manipulations lead to modification of the stored data, and consequently, the previous version of the data is not available in the system. The historical data is crucial for various operations (such as trend analysis, predictive analysis, auditing, automating a task, detecting long-term anomalies, or the like) involved with the digitized and automated system. The non-availability of historical data in the digitized and automated system may prevent the execution of various critical operations therein.

In light of the foregoing, there exists a need for a technical and reliable solution that overcomes the abovementioned problems.

Limitations and disadvantages of conventional and traditional approaches will become apparent to one of skill in the art, through the comparison of described systems with some aspects of the present disclosure, as set forth in the remainder of the present application and with reference to the drawings.

### SUMMARY

Methods and systems for facilitating in-situ history using an executable graph-based model are provided substantially as shown in, and described in connection with, at least one of the figures.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

Embodiments of the present disclosure are illustrated by way of example and are not limited by the accompanying figures. Similar references in the figures may indicate similar elements. Elements in the figures are illustrated for simplicity and clarity and have not necessarily been drawn to scale.

FIG. 1 is a graph that illustrates a composition of an executable graph-based model, in accordance with an embodiment of the present disclosure;

FIG. 2 is a block diagram that illustrates a system environment of an overlay system for execution, management, and configuration of executable graph-based models, in accordance with an embodiment of the present disclosure;

FIG. 3 is a block diagram that illustrates a generic structure of a node within the executable graph-based model, in accordance with an embodiment of the present disclosure;

FIG. 4A is a block diagram that illustrates a first executable node within the executable graph-based model, in accordance with an embodiment of the present disclosure;

FIG. 4B is a block diagram that illustrates a second executable node within the executable graph-based model, in accordance with another embodiment of the present disclosure;

FIG. 5 is a block diagram that illustrates a templated active node within a templated version of the executable graph-based model, in accordance with an embodiment of the present disclosure;

FIG. 6 is a block diagram that illustrates a composition of the first executable node that enables persistent storage of data and processing logic associated therewith, in accordance with an embodiment of the present disclosure;

FIGS. 7A-7D are schematic diagrams that, collectively, illustrate generation, maintenance, and utilization of in-situ history in the executable graph-based model, in accordance with an embodiment of the present disclosure;

FIG. 8 is a schematic diagram that illustrates an example implementation of in-situ history in an executable graph-based robotic arm model, in accordance with an embodiment of the present disclosure;

FIG. 9 shows an example computing system for carrying out methods of the present disclosure, in accordance with an embodiment of the present disclosure; and

FIG. 10 is a flowchart that illustrates a method for facilitating in-situ history using the executable graph-based model, in accordance with an embodiment of the present disclosure.

### DETAILED DESCRIPTION

The detailed description of the appended drawings is intended as a description of the embodiments of the present disclosure and is not intended to represent the only form in which the present disclosure may be practiced. It is to be understood that the same or equivalent functions may be accomplished by different embodiments that are intended to be encompassed within the spirit and scope of the present disclosure.

### Overview:

Storing of data in a system and manipulation of the stored data is crucial for the digitization and automation of the system associated with various applications such as healthcare, finance, warehouse, or the like. Conventionally, to ensure the availability of previous versions of the data (e.g., historical data), the historical data is stored in a storage element that is external to the digitized and automated system. The digitized and automated system retrieves the historical data from the external storage element for various operations involved with the digitized and automated system. Examples of the operation include trend analysis, predictive analysis, auditing, automating a task, detecting long-term anomalies, or the like. However, storing the historical data externally leads to increased latency while retrieving the historical data for real-time processing. The increased latency may lead to undesirable outcomes during real-time operations.

The present disclosure is directed to the facilitation of in-situ history in executable graph-based models. The executable graph-based models are stored in a storage element of an overlay system. The executable graph-based models are customized hypergraphs having hyper-edges edges that include one or more roles, and vertices that are realized by way of active nodes. Each active node is a data node that is extended by way of one or more overlays. Each active node is associated with a particular node type. For example, an edge node corresponds to a data node with an edge node type. Nodes (for example, data nodes and active nodes) are connected with other nodes by way of edge nodes (e.g., roles included in the edge nodes). In some embodiments, roles are represented by way of nodes of role node type. Role node between two nodes may be indicative of details regarding an association therebetween. Further, an active node whose history is required in the executable graph-based model may be associated with history overlay nodes. The history overlay nodes include processing logic for facilitating the generation and maintenance of historical versions of the active node in the executable graph-based models. The historical versions of the active node are maintained as history nodes in the executable graph-based models, thereby facilitating in-situ history. As a result, an operation, associated with the overlay system, that requires the historical versions of various active nodes is executed in significantly less time.

In an example, the executable graph-based model may include a first active node and a first history overlay node that is an overlay of the first active node. The version of such an active node is referred to as a first active version of the first active node. In operation, processing circuitry of the overlay system may receive a first stimulus that indicates a mutation of the first active node. In such a scenario, the processing circuitry creates a cloned first active node and transfers the first history overlay node to the cloned first active node. The first active version of the first active node that is without the history overlay node is converted into a first history node. Additionally, the cloned first active node is mutated based on the first stimulus, thereby resulting in a second active version of the first active node. Further, the processing circuitry may receive a second stimulus that indicates a requirement of the first history node and the second active version of the first active node for executing an operation. In such a scenario, the processing circuitry identifies the second active version of the first active node and the first history node, and executes an operation associated with the second stimulus by utilizing the second active version of the first active node, the first history overlay node, and the first history node.

Traditional approach of maintaining historical versions of active nodes involves storing the historical versions in an external storage element and fetching the historical versions from the storage element to execute an operation. Fetching of the historical versions from the external storage element results in increased latency during the execution of the operation. In contrast, the present disclosure provides in-situ history in the overlay system that avoids the fetching of the historical versions from the external storage element, thus significantly reducing the latency during the execution of the operation.

Systems and methods for facilitating in-situ history in the executable graph-based models are provided. The systems and methods disclosed herein facilitate the generation and maintenance of historical data at the node level that allows the required historical data to be retrieved from within the executable graph-based model. Hence, the disclosed systems and methods provide an approach for the retrieval of historical data using executable graph-based models that exhibit significantly reduced latency during such retrieval. As a result, the time complexity associated with the historical data retrieval is reduced. The reduction in time complexity is beneficial in applications such as healthcare, finance, warehouses, or the like, that involve crucial operations based on the historical data retrieval. Further, the disclosed systems and methods do not require the data and processing logic to be available at all times, and hence, the data and processing logic when not in use may be stored separately and re-loaded in the corresponding executable node when needed. Thus, the systems and methods disclosed herein provide an efficient approach for in-situ history in the executable graph-based models in a secured and seamless manner.

### Figure Description:

FIG. 1 is a graph that illustrates a composition of an executable graph-based model 100, in accordance with an embodiment of the present disclosure. Referring to FIG. 1, the executable graph-based model 100 is generally formed of a data structure (e.g., a graph-based model or a graphical model) comprising a plurality of nodes 102-106 which can be functionally extended with processing logic via the use of overlays. For example, as shown in FIG. 1, the nodes 104 and 106 are functionally extended with processing logic via the use of overlays 108 and 110, respectively. Although not shown, it will be apparent to a person skilled in the art that the node 102 can be similarly extended with processing logic via the use of one or more overlays. Each overlay includes processing logic, such as processing logic 112 and 114 which are associated with the overlays 108 and 110, respectively. At run-time, data, such as data 116 and 118, is associated with the nodes 102 and 106, respectively, of the executable graph-based model 100. Further, the overlays 108 and 110 of the nodes 104 and 106, respectively, provide the functionality to respond to stimuli and interact with, manipulate, or otherwise process the data for generation of history, maintenance of the history, and utilization of the history based on the stimuli. Further, the node 104 inherits the node 102, and hence, also inherits the data 116 which is associated with the node 102. In some embodiments, the node 102 may be extended to have one or more overlays. In such embodiments, the node 104 may further inherit the overlays of the node 102.

Each element within the executable graph-based model 100 (both the data and the processing functionality) is a node. A node forms the fundamental building block of all executable graph-based models. A node may be an executable node. A node extended by way of an overlay node forms an executable node. One or more nodes are extended to include overlays in order to form the executable graph-based models. As such, the executable graph-based model 100 includes one or more nodes that can be dynamically generated, extended, or processed by one or more other modules within an overlay system (shown in FIG. 2).

As such, the structure and functionality of the data processing are separate from the data itself when offline (or at rest) and are combined dynamically at run-time. The executable graph-based model 100 thus maintains the separability of the data and the processing logic when offline. Moreover, by integrating the data and the processing logic within a single model, processing delays or latencies are reduced because the data and the processing logic exist within the same logical system. Therefore, the executable graph-based model 100 is applicable to a range of time-critical systems where efficient processing of the stimuli is required. In an instance, the executable graph-based model 100 may be used for in-situ processing of stimuli such as a command, a query, or the like.

FIG. 2 is a block diagram that illustrates a system environment 200 of an overlay system 202 for execution, management, and configuration of executable graph-based models, in accordance with an embodiment of the present disclosure. Referring to FIG. 2, the overlay system 202 includes the executable graph-based model 100. The overlay system 202 further includes an interface module 204, a controller module 206, a transaction module 208, a context module 210, a stimuli management module 212, an overlay management module 214, a memory management module 216, a storage management module 218, a security module 220, and a history management module 222. FIG. 2 further shows a configuration 224, a set of contexts 226, a dataset 228, a set of stimuli 230, a network 232, and an outcome 234.

The overlay system 202 may include suitable logic, circuitry, interfaces, and/or code, executable by the circuitry, that may be configured to facilitate in-situ history in the executable graph-based models (such as the executable graph-based model 100). The executable graph-based model 100 corresponds to an application-specific combination of data and processing functionality which is manipulated, processed, and/or otherwise handled by other modules within the overlay system 202 for generation, maintenance, and utilization (e.g., processing) of history therein based on the set of stimuli 230 received by the overlay system 202. Each stimulus in the set of stimuli 230 corresponds to a command or a query.

The interface module 204 may include suitable logic, circuitry, interfaces, and/or code, executable by the circuitry, configured to provide a common interface between internal modules of the overlay system 202 and/or external sources. The interface module 204 provides an application programmable interface (API), scripting interface, or any other suitable mechanism for interfacing externally or internally with any module of the overlay system 202. As shown in FIG. 1, the configuration 224, the set of contexts 226, the dataset 228, and the set of stimuli 230 are received by the interface module 204 via the network 232. Similarly, outputs produced by the overlay system 202, such as the outcome 234, are passed by the interface module 204 to the network 232 for consumption or processing by external systems. In one embodiment, the interface module 204 supports one or more messaging patterns or protocols such as the simple object access protocol (SOAP), the representational state transfer (REST) protocol, or the like. The interface module 204 thus allows the overlay system 202 to be deployed in any number of application areas, operational environments, or architecture deployments. Although not illustrated in FIG. 1, the interface module 204 is communicatively coupled (e.g., connected either directly or indirectly) to one or more other modules or elements within the overlay system 202 (such as the controller module 206, the context module 210, the executable graph-based model 100, or the like). In one embodiment, the interface module 204 is communicatively coupled (e.g., connected either directly or indirectly) to one or more overlays within the executable graph-based model 100.

The controller module 206 may include suitable logic, circuitry, interfaces, and/or code, executable by the circuitry, configured to handle and process interactions and executions within the overlay system 202. As will be described in more detail below, stimuli (such as the set of stimuli 230) and their associated contexts provide the basis for all interactions within the executable graph-based model 100. Processing of such stimuli may lead to the execution of processing logic associated with one or more overlays within the executable graph-based model 100. The processing of the stimuli within the overlay system 202 may be referred to as a system transaction. The processing and execution of stimuli (and associated overlay execution) within the overlay system 202 is handled by the controller module 206. The controller module 206 manages all received input stimuli and processes them based on a corresponding context. Each context determines the priority that is assigned to process the corresponding stimulus by the controller module 206 or the context module 210. This allows each stimulus to be configured with a level of importance and prioritization within the overlay system 202.

The controller module 206 may maintain the integrity of the modules within the overlay system 202 before, during, and after a system transaction. The transaction module 208, which is associated with the controller module 206, is responsible for maintaining the integrity of the overlay system 202 through the lifecycle of a transaction. Maintaining system integrity via the controller module 206 and the transaction module 208 allows a transaction to be rolled back in the event of an expected or unexpected software or hardware fault or failure. The controller module 206 is configured to handle the processing of the set of stimuli and transactions through architectures such as parallel processing, grid computing, priority queue techniques, or the like. In one embodiment, the controller module 206 and the transaction module 208 are communicatively coupled (e.g., connected either directly or indirectly) to one or more overlays within the executable graph-based model 100.

As stated briefly above, the overlay system 202 utilizes a context-driven architecture whereby the set of stimuli 230 within the overlay system 202 is associated with the set of contexts 226 which is used to adapt the handling or processing of the set of stimuli 230 by the overlay system 202. The handling or processing of the set of stimuli 230 is done based on the set of contexts 226 associated therewith. Hence, each stimulus of the set of stimuli 230 is considered to be a contextualized stimulus. The set of contexts 226 may include details such as user name, password, access token, device information, time stamp, one or more relevant identifiers, or the like, that are required for processing of the set of stimuli 230 within the executable graph-based model 100. Each context within the overlay system 202 may be extended to include additional information that is required for the processing of the corresponding stimulus (e.g., a query or a command).

The context module 210 may include suitable logic, circuitry, interfaces, and/or code, executable by the circuitry, configured to manage the handling of contexts within the overlay system 202, and is responsible for processing any received contexts (e.g., the set of contexts 226) and translating the received context to an operation execution context. In some examples, the operation execution context is larger than the received context because the context module 210 supplements the received context with further information necessary for the processing of the received context. The context module 210 passes the operational execution context to one or more other modules within the overlay system 202 to facilitate the generation, maintenance, and utilization of in-situ history in the executable graph-based model 100. Contexts within the overlay system 202 can be external or internal. While some contexts apply to all application areas and problem spaces, some applications may require specific contexts to be generated and used to process the received set of stimuli 230. As will be described in more detail below, the executable graph-based model 100 is configurable (e.g., via the configuration 224) so as only to execute within a given execution context for a given stimulus.

The stimuli management module 212 may include suitable logic, circuitry, interfaces, and/or code, executable by the circuitry, configured to process externally received stimuli (e.g., the set of stimuli 230) and any stimuli generated internally from any module within the overlay system 202. The stimuli management module 212 is communicatively coupled (e.g., connected either directly or indirectly) to one or more overlays within the executable graph-based model 100 to facilitate the processing of stimuli within the executable graph-based model 100. The overlay system 202 utilizes different types of stimuli such as a command (e.g., a transactional request), or a query received from an external system such as an Internet-of-Things (IoT) device. As previously stated, each stimulus of the set of stimuli 230 can be either externally or internally generated. In an example, each stimulus of the set of stimuli 230 may be a message that is internally triggered (generated) from any of the modules within the overlay system 202. Such internal generation of the set of stimuli 230 indicates that something has happened within the overlay system 202 such that subsequent handling by one or more other modules within the overlay system 202 may be required. An internal set of stimuli 230 can also be triggered (generated) from the execution of processing logic associated with overlays within the executable graph-based model 100. In another example, the set of stimuli 230 may be externally triggered and may be generated based on an input received via a user interface associated with the controller module 206. The externally triggered set of stimuli 230 may be received in the form of a textual, audio, or visual input. The externally triggered set of stimuli 230 may be associated with the intent of a user to execute a set of operations indicated by the set of stimuli 230. The operation is executed in accordance with the information included in the set of contexts 226 associated with the set of stimuli 230.

The stimuli management module 212 may receive the stimuli in real-time or near-real-time and communicate the received set of stimuli 230 to one or more other modules or nodes of the executable graph-based model 100. In some examples, the stimuli are scheduled in a batch process. The stimuli management module 212 utilizes any suitable synchronous or asynchronous communication architectures or approaches in communicating the stimuli (along with associated information). The stimuli within the overlay system 202 are received and processed (along with a corresponding context) by the stimuli management module 212, which then determines the processing steps to be performed for the execution of operations associated with each stimulus of the set of stimuli 230. In one embodiment, the stimuli management module 212 processes the received stimuli in accordance with a predetermined configuration (e.g., the configuration 224) or dynamically determines what processing needs to be performed based on the contexts associated with the stimuli and/or based on a state of the executable graph-based model 100. The state of the executable graph-based model 100 refers to the current state of each node of the executable graph-based model 100 at a given point in time. The state of the executable graph-based model 100 is dynamic, and hence, may change in response to the execution of an operation based on any of its nodes. In some examples, the processing of each stimulus of the set of stimuli 230 results in the generation, maintenance, or utilization of history that further results in one or more outcomes being generated (e.g., the outcome 234). Such outcomes are either handled internally by one or more modules in the overlay system 202 or communicated via the interface module 204 as an external outcome. In one embodiment, all stimuli and corresponding outcomes are recorded for auditing and post-processing purposes by, for example, an operations module (not shown) and/or an analytics module (not shown) of the overlay system 202.

The overlay management module 214 may include suitable logic, circuitry, interfaces, and/or code, executable by the circuitry, configured to manage all overlays within the overlay system 202. Operations performed by the overlay management module 214 include overlay storage management, overlay structure modeling, overlay logic creation and execution, and overlay loading and unloading (within the executable graph-based model 100). The overlay management module 214 is communicatively coupled (e.g., connected either directly or indirectly) to one or more other modules within the overlay system 202 to complete some or all of these operations. For example, overlays can be persisted in some form of physical storage using the storage management module 218 (as described in more detail below). As a further example, overlays can be compiled and preloaded into memory via the memory management module 216 for faster run-time execution.

The memory management module 216 may include suitable logic, circuitry, interfaces, and/or code, executable by the circuitry, configured to manage and optimize the memory usage of the overlay system 202. The memory management module 216 thus helps to improve the responsiveness and efficiency of the processing performed by one or more of the modules within the overlay system 202 by optimizing the memory handling performed by these modules. The memory management module 216 uses direct memory or some form of distributed memory management architecture (e.g., a local or remote caching solution). Additionally, or alternatively, the memory management module 216 deploys multiple different types of memory management architectures and solutions (e.g., reactive caching approaches such as lazy loading or a proactive approach such as write-through cache may be employed). These architectures and solutions are deployed in the form of a flat (single-tiered) cache or a multi-tiered caching architecture where each layer of the caching architecture can be implemented using a different caching technology or architecture solution approach. In such implementations, each cache or caching tier can be configured (e.g., by the configuration 224) independently of the requirements for one or more modules of the overlay system 202. For example, data priority and an eviction strategy, such as least-frequently-used (LFU) or least-recently-used (LRU), can be configured for all or parts of the executable graph-based model 100. In one embodiment, the memory management module 216 is communicatively coupled (e.g., connected either directly or indirectly) to one or more overlays within the executable graph-based model 100.

The storage management module 218 may include suitable logic, circuitry, interfaces, and/or code, executable by the circuitry, configured to manage the temporary or permanent storage of data associated with messages being communicated within the overlay system 202. The storage management module 218 is any suitable low-level storage device solution (such as a file system) or any suitable high-level storage technology such as another database technology (e.g., relational database management system (RDBMS) or NoSQL database). The storage management module 218 is directly connected to the storage device upon which the relevant data is persistently stored. For example, the storage management module 218 can directly address the computer-readable medium (e.g., hard disk drive, external disk drive, or the like) upon which the data is being read or written. Alternatively, the storage management module 218 is connected to the storage device via a network such as the network 232. As will be described in more detail later in the present disclosure, the storage management module 218 uses ‘manifests’ to manage the interactions between the storage device and the modules within the overlay system 202. In one embodiment, the storage management module 218 is communicatively coupled (e.g., connected either directly or indirectly) to one or more overlays within the executable graph-based model 100.

As described, storage, loading, and unloading of the executable graph-based model 100 or one or more components thereof may be facilitated by the memory management module 216 and the storage management module 218. The memory management module 216 and the storage management module 218 may facilitate such operations by interacting with the storage device. In the present disclosure, the executable graph-based model 100 may be stored in a storage element. The storage element corresponds to a combination of the memory management module 216 and the storage management module 218 that may be configured to store the executable graph-based model 100. In some embodiments, the storage element may be a storage module that is managed by the memory management module 216 and the storage management module 218, collectively.

The security module 220 may include suitable logic, circuitry, interfaces, and/or code, executable by the circuitry, configured to manage the security of the overlay system 202. This includes security at a system level and a module level. Security is hardware-related, network-related, or software-related, depending on the operational environment, the architecture of the deployment, or the data and information contained within the overlay system 202. For example, if the system is deployed with a web-accessible API (as described above in relation to the interface module 204), the security module 220 can enforce a hypertext transfer protocol secure (HTTPS) protocol with the necessary certification. As a further example, if the data or information associated with the message received or processed by the overlay system 202 contains Personally Identifiable Information (PII) or Protected Health Information (PHI), the security module 220 can implement one or more layers of data protection to ensure that the PII or PHI is correctly processed and stored. In an additional example, in implementations where the overlay system 202 operates on United States of America citizen medical data, the security module 220 may enforce additional protections or policies as defined by the United States Health Insurance Portability and Accountability Act (HIPAA). Similarly, if the overlay system 202 is deployed in the European Union (EU), the security module 220 may enforce additional protections or policies to ensure that the data processed and maintained by the overlay system 202 complies with the General Data Protection Regulation (GDPR). In one embodiment, the security module 220 is communicatively coupled (e.g., connected either directly or indirectly) to one or more overlays within the executable graph-based model 100 thereby directly connecting security execution to the data/information in the executable graph-based model 100.

The history management module 222 may include suitable logic, circuitry, interfaces, and/or code, executable by the circuitry, configured to manage all data and information associated with the generation, maintenance, and utilization of the in-situ history within the overlay system 202. Operations performed by the history management module 222 may include the generation, maintenance, and utilization of the history. In an example, the history refers to one or more historical versions of the plurality of nodes 102-106. The one or more historical versions are generated based on one or more stimuli (such as the set of stimuli 230). The history management module 222 is communicatively coupled (e.g., connected either directly or indirectly) to one or more other modules within the overlay system 202 to complete some or all of these operations. The history management module 222 is further communicatively coupled (i.e., connected either directly or indirectly) to one or more nodes and/or one or more overlays within the executable graph-based model 100.

In addition to the abovementioned components, the overlay system 202 further includes a data management module 236. The data management module 236 may include suitable logic, circuitry, interfaces, and/or code, executable by the circuitry, configured to manage all data or information (e.g., the dataset 228) within the overlay system 202 for a given application. Operations performed by the data management module 236 include data loading, data unloading, data modeling, and data processing. The data management module 236 is communicatively coupled (e.g., connected either directly or indirectly) to one or more other modules within the overlay system 202 to complete some or all of these operations. For example, data storage is handled by the data management module 236 in conjunction with the storage management module 218.

In one embodiment of the present disclosure, the overlay system 202 may further include a templating module 238. The templating module 238 may include suitable logic, circuitry, interfaces, and/or code, executable by the circuitry, configured to implement a templated version of the executable graph-based model 100. The templating module 238 may be further configured to generate specific instances of nodes from predefined templates for the implementation of the templated version of the executable graph-based model 100. In other words, the templating module 238 ensures ontology integrity by enforcing the structure and rules of a template when generating instances of the template at run-time. The templating module 238 is communicatively coupled (i.e., connected either directly or indirectly) to one or more nodes and/or one or more overlays within the templated version of the executable graph-based model 100. The templated version of the executable graph-based model 100 is explained further in conjunction with FIG. 5.

In some embodiments, all the modules of the overlay system 202 except for the executable graph-based model 100 may collectively form processing circuitry that executes operations associated with the generation, maintenance, and utilization of in-situ history within the overlay system 202.

The functionality of two or more of the modules included in the overlay system 202 may be combined within a single module. Conversely, the functionality of a single module can be split into two or more further modules which can be executed on two or more devices. The modules described above in relation to the overlay system 202 can operate in a parallel, distributed, or networked fashion. The overlay system 202 may be implemented in software, hardware, or a combination of both software and hardware. Examples of suitable hardware modules include a general-purpose processor, a field programmable gate array (FPGA), and/or an application-specific integrated circuit (ASIC). Software modules can be expressed in a variety of software languages such as C, C++, Java, Ruby, Visual Basic, Python, and/or other object-oriented, procedural, or programming languages.

It will be apparent to a person skilled in the art that whilst only one executable graph-based model 100 is shown in FIG. 2, in other embodiments the overlay system 202 stores and maintains more than one executable graph-based model, without deviating from the scope of the present disclosure. In such embodiments, generation, maintenance, and utilization of in-situ history in each executable graph-based model is in a manner that is similar to that in the executable graph-based model 100.

Having described the overlay system 202 for executing and managing executable graph-based models, the description will now turn to the elements of an executable graph-based model; specifically, the concept of a node. Unlike conventional graph-based systems, all elements (e.g., data, overlays, etc.) within the executable graph-based model (e.g., the executable graph-based model 100) are implemented as nodes. As will become clear, this allows executable graph-based models to be flexible, extensible, and highly configurable.

FIG. 3 is a block diagram 300 that illustrates a generic structure of a node 302 within the executable graph-based model 100, in accordance with an embodiment of the present disclosure. Referring to FIG. 3, the node 302 corresponds to the core structure of the executable graph-based model 100 and forms the foundational building block for all data and processing logic within the executable graph-based model 100. The node 302 includes properties 304, inheritance identifiers (IDs) 306, and a node type 308. The node 302 optionally includes one or more attributes 310, metadata 312 associated with the attributes 310, and a node configuration 314.

The properties 304 of the node 302 include a unique ID 304a, a version ID 304b, a namespace 304c, and a name 304d. The properties 304 optionally include one or more icons 304c, one or more labels 304f, and one or more alternative IDs 304g. The inheritance IDs 306 of the node 302 comprise an abstract flag 316, a leaf flag 318, and a root flag 320. The node configuration 314 optionally includes one or more node configuration strategies 322 and one or more node configuration extensions 324. FIG. 3 further shows a plurality of predetermined node types 326 which include a vertex node type 328, an edge node type 330, a role node type 332, and an overlay node type 334.

The unique ID 304a is unique for each node within the executable graph-based model 100. The unique ID 304a is used to register, manage, and reference the node 302 within the system (e.g., the overlay system 202). In some embodiments, the one or more alternative IDs 304g are associated with the unique ID 304a to help manage communications and connections with external systems (e.g., during configuration, sending stimuli, or receiving outcomes). The version ID 304b of the node 302 is incremented when the node 302 undergoes transactional change. This allows the historical changes between versions of the node 302 to be tracked by modules or overlays within the overlay system 202. The namespace 304c of the node 302, along with the name 304d of the node 302, is used to help organize nodes within the executable graph-based model 100. That is, the node 302 is assigned a unique name 304d within the namespace 304c such that the name 304d of the node 302 need not be unique within the entire executable graph-based model 100, only within the context of the namespace 304c to which the node 302 is assigned. The node 302 optionally includes one or more icons 304c which are used to provide a visual representation of the node 302 when visualized via a user interface. The one or more icons 304e can include icons at different resolutions and display contexts such that the visualization of the node 302 is adapted to different display settings and contexts. The node 302 also optionally includes one or more labels 304f which are used to override the name 304d when the node 302 is rendered or visualized.

The node 302 supports the concept of inheritance of data and processing logic associated with any other node of the executable graph-based model 100 that is inherited by the node 302. This allows the behavior and functionality of the node 302 to be extended or derived from the inherited node of the executable graph-based model 100. The inheritance IDs 306 of the node 302 indicates the inheritance-based information, which may be applicable to the node 302. The inheritance IDs 306 comprise a set of Boolean flags which identify the inheritance structure of the node 302. The abstract flag 316 allows the node 302 to support the construct of abstraction. When the abstract flag 316 takes a value of ‘true’, the node 302 is flagged as abstract that is to say that it cannot be instantiated or created within an executable graph-based model (e.g., the executable graph-based model 100). Thus, in an instance when the node 302 has the abstract flag 316 set to ‘true’, the node 302 may only form the foundation of other nodes that inherit therefrom. By default, the abstract flag 316 of the node 302 is set to ‘false’. The leaf flag 318 is used to indicate whether any other node may inherit from the node 302. If the leaf flag 318 is set to ‘true’, then no other node may inherit from the node 302 (but unlike an abstract node, a node with the leaf flag 318 set to ‘true’ may be instantiated and created within the executable graph-based model 100). The root flag 320 is used to indicate whether the node 302 inherits from any other node. If the root flag 320 is set to ‘true’, the node 302 does not inherit from any other node. The node 302 is flagged as leaf (e.g., the leaf flag 318 is set to ‘true’) and/or root (e.g., the root flag 320 is set to ‘true’), or neither (e.g., both the leaf flag 318 and the root flag 320 are set to ‘false’). It will be apparent to a person skilled in the art that a node cannot be flagged as both abstract and leaf (e.g., the abstract flag 316 cannot be set to ‘true’ whilst the leaf flag 318 is set to ‘true’).

As stated above, all elements of the executable graph-based model 100 are defined as nodes. This functionality is in part realized due to the use of a node type. The node type 308 of the node 302 is used to extend the functionality of the node 302. All nodes within the executable graph-based model 100 comprise a node type that defines additional data structures and implements additional executable functionality. A node type thus includes data structures and functionality that are common across all nodes that share that node type. The composition of a node with a node type therefore improves extensibility by allowing the generation of specialized node functionalities for specific application areas. Such extensibility is not present in prior art graph-based models. As illustrated in FIG. 3, the node 302 and the node type 308 are one logical unit that is not separated in the context of an executing system at run-time (e.g., in the context of execution of an executable graph-based model).

FIG. 3 further shows the plurality of predetermined node types 326 which provides a non-exhaustive list of node types that may be associated with a node, such as the node 302. The vertex node type 328 (also referred to as a data node type) includes common data structures and functionality related to the ‘things’ modeled in the graph (e.g., the data). The edge node type 330 includes common data structures and functionality related to joining two or more nodes. A node having the edge node type 330 may connect two or more nodes and thus the edge node type 330 constructs associations and connections between nodes (for example objects or ‘things’) within the executable graph-based model 100. The edge node type 330 is not restricted to the number of nodes that can be associated or connected by a node having the edge node type 330. The data structures and functionality of the edge node type 330 thus define a hyper-edge which allows two or more nodes to be connected through a defined set of role nodes. A role node type 332 includes common data structures and functionality related to defining relationships between the two or more nodes. A node having the role node type 332 may define a connective relationship between the two or more nodes, and hence, allows an edge node to connect two or more nodes such that the two or more nodes may have more than one relationship therebetween. The plurality of predetermined node types 326 further includes the overlay node type 334. As will be described in more detail below, the overlay node type 334 is used to extend the functionality of a node, such as the node 302, to incorporate processing logic.

The one or more attributes 310 correspond to the data associated with the node 302 (e.g., the data represented by the node 302 within the executable graph-based model 100 as handled by the data management module 236). Notably, a node in the executable graph-based model 100 that is not associated with data may not have any attributes. The one or more attributes 310 represent a complex data type. Each attribute of the one or more attributes 310 is composed of an attribute behavior. Attribute behavior may be a standard attribute behavior, a reference attribute behavior, a derived attribute behavior, or a complex attribute behavior. The attribute behavior of each attribute defines the behavior of the corresponding attribute. The attribute behavior of each attribute may be configured by associated attribute configurations. The attribute configurations are examples of attribute configuration extensions which are node configuration extensions (e.g., they are part of the one or more node configuration extensions 324 of the node 302 shown in FIG. 3). The standard attribute behavior may be configured by a standard attribute configuration, the reference attribute behavior may be configured by a reference attribute configuration, the derived attribute behavior is configured by a derived attribute configuration, and the complex attribute behavior is configured by a complex attribute configuration.

The standard attribute behavior is a behavior that allows read-write access to the data of the corresponding attribute. The reference attribute behavior is a behavior that allows read-write access to the data of the corresponding attribute but restricts possible values of the data to values defined by a reference data set. The reference attribute configuration associated with reference attribute behavior includes appropriate information to obtain a reference data set of possible values. The derived attribute behavior is a behavior that allows read-only access to data of the corresponding attribute. Also, data of the corresponding attribute is derived from other data, or information, within the executable graph-based model 100 in which an executable node of the corresponding attribute is used. The data is derived from one or more other attributes associated with the node or is derived from more complex expressions depending on the application area. In one embodiment, the derived attribute configuration (which is used to configure the derived attribute behavior) includes mathematical and/or other forms of expressions (e.g., regular expressions, templates, or the like) that are used to derive the data (value) of the corresponding attribute. The complex attribute behavior is a behavior that allows the corresponding attribute to act as either a standard attribute behavior if the data of the corresponding attribute is directly set, or a derived attribute behavior if the data of the corresponding attribute is not directly set.

As shown, the node 302 further includes the metadata 312 (e.g., data stored as a name, a count of processed messages, time when the last message was processed, an average processing time required for processing a message, or the like) which is associated with either the node 302 or an attribute (for example, the one or more attributes 310) of the node 302.

An attribute within the one or more attributes 310 may either have an independent or shared state. An independent attribute has data that is not shared with any other node within the executable graph-based model 100. Conversely, a shared attribute has data that is shared with one or more other nodes within the executable graph-based model 100. For example, if two nodes within the executable graph-based model 100 both comprise a shared-data attribute with a value state shared by both nodes, then updating the data (e.g., the value) of this shared attribute will be reflected across both nodes.

The node configuration 314 provides a high degree of configurations for the different elements of the node 302. The node configuration 314 optionally includes the one or more node configuration strategies 322 and/or the one or more node configuration extensions 324 which are complex data types. An example of a concrete node configuration strategy is an ID strategy, associated with the configuration of the unique ID 304a of the node 302, which creates message source IDs. A further example of a concrete node configuration strategy is a versioning strategy, associated with the configuration of the version ID 304b of the node 302, which supports major and minor versioning (depending on the type of transactional change incurred by the node 302). The versioning strategy may be adapted to a native filing system of a user device hosting the overlay system 202 or a third-party data storage (for example, Snowflake®, or the like) associated with the overlay system 202.

FIG. 4A is a block diagram that illustrates a first executable node 402 within the executable graph-based model 100, in accordance with an embodiment of the present disclosure. Referring to FIG. 4A, the first executable node 402 is shown to include a first active node, e.g., the node 302, and an overlay manager 404. In the executable graph-based model 100 of FIG. 4A, the node 302 is alternatively referred to as the “first active node 302”. The first active node 302 corresponds to a data node. In other words, the first active node 302 is associated with data. The overlay manager 404 includes an overlay node 406. The overlay node 406 has a history overlay node type 408. Thus, the overlay node 406 may be interchangeably referred to as “the history overlay node 406”. The history overlay node 406 being a node adheres to the generic structure of a node described in conjunction with FIG. 3.

The first executable node 402 extends the first active node 302 (or is a subtype of the first active node 302) such that all the functionality and properties of the first active node 302 are accessible to the first executable node 402. The first executable node 402 also dynamically extends the functionality of the first active node 302 by associating the overlay nodes maintained by the overlay manager 404 with the first active node 302. The first executable node 402 may thus be considered a composition of the first active node 302 and the history overlay node 406. The first executable node 402 may be alternatively referred to as a node with overlay. Therefore, the first executable node 402 acts as a decorator of the first active node 302 adding the functionality of the overlay manager 404 to the active node 302.

It will be apparent to a person skilled in the art that the first active node 302 refers to any suitable node within the executable graph-based model 100. As such, the first active node 302 may be a node having a type such as a vertex node type, an edge node type, or the like.

The overlay manager 404 registers and maintains one or more overlay nodes (such as the history overlay node 406) associated with the first active node 302. The assignment of the history overlay node 406 to the first active node 302 (via the overlay manager 404) endows the first active node 302 with processing logic and executable functionality defined within the history overlay node 406.

Extending the functionality of an active node through one or more overlay nodes is at the heart of the overlay system 202. As illustrated in FIG. 2, the data (e.g., a vertex node as represented by the first active node 302 in FIG. 4A) and the functionality that acts upon that data (e.g., an overlay node) can be separated and independently maintained offline, but at run-time, an association between the data node and the overlay node is determined and an executable node is generated (e.g., the first executable node 402 shown in FIG. 4A).

An overlay node, such as the overlay node 406 is a node having an overlay node type (alternatively referred to as an overlay type) assigned to its node type. As shown in FIG. 4A, the overlay node 406 has the history overlay node type 408. Thus, the functionality of the first active node 302 is extended to facilitate the generation, maintenance, and utilization of a set of history nodes associated with the first active node 302 within the executable graph-based model 100, with each history node referring to a historical version of the first active node 302. The generation, maintenance, and utilization of the set of history nodes associated with the first active node 302 is described in detail in conjunction with FIGS. 7A-7D. Additionally, the history overlay node 406 is configured to indicate a history depth and a history retention period associated with the first active node 302. The history depth indicates a maximum number of history nodes associated with the first active node 302. Further, the history retention period indicates a maximum time duration for which each history node of the set of history nodes associated with the first active node 302, is retained in the overlay system 202. The history depth and the history retention period aid in the generation, maintenance, and utilization of the set of history nodes associated with the first active node 302.

FIG. 4B is a block diagram that illustrates a second executable node 409 within the executable graph-based model 100, in accordance with another embodiment of the present disclosure.

Referring to FIG. 4B, the second executable node 409 is shown to include a data node, e.g., the node 302, and an overlay manager 410. In the executable graph-based model 100 of FIG. 4B, the node 302 is alternatively referred to as the “data node 302”. The data node 302 refers to any suitable node within the executable graph-based model 100. As such, the data node 302 may be a node having a type such as a vertex node type, an edge node type, or the like. The overlay manager 410 includes an overlay node 412 and an overlay node 414. The overlay node 412 has a non-history overlay node type 416 and the overlay node 414 has the history overlay node type 408. Thus, the overlay node 412 and the overlay node 414 may be interchangeably referred to as the non-history overlay node 412 and the history overlay node 414, respectively. A combination of the data node 302 and the overlay node 412 is referred to as a second active node 418. In other words, the second active node 418 comprises the data node 302 and the non-history overlay node 412. Further, the non-history overlay node 412 is associated with an overlay manager 420. The overlay manager 420 includes an overlay node 422. The overlay node 422 has the history overlay node type 408. Thus, the overlay node 422 may be interchangeably referred to as the history overlay node 422. Alternatively, the second executable node 409 may also be referred to as the second active node 418 associated with a set of history overlay nodes such that the set of history overlay nodes includes the history overlay node 414 and the history overlay node 422.

The second executable node 409 extends the data node 302 (or is a subtype of the first active node 302) such that all the functionality and properties of the data node 302 are accessible to the second executable node 409. The second executable node 409 also dynamically extends the functionality of the data node 302 by associating the overlay nodes maintained by the overlay manager 410 with the data node 302. The second executable node 409 may thus be considered a composition of the data node 302, the non-history overlay node 412, and the history overlay node 414. The second executable node 409 may be alternatively referred to as a node with overlay(s). Therefore, the second executable node 409 acts as a decorator of the data node 302 adding the functionality of the overlay manager 410 to the data node 302.

The overlay manager 410 registers and maintains one or more overlay nodes (such as the non-history overlay node 412 and the history overlay node 414) associated with the data node 302. The assignment of the non-history overlay node 412 and the history overlay node 414 to the data node 302 (via the overlay manager 410) endows the data node 302 with processing logic and executable functionality defined within the non-history overlay node 412 and the history overlay node 414. The overlay manager 420 registers and maintains one or more overlay nodes (such as the history overlay node 422) associated with the non-history overlay node 412. The non-history overlay node 412 may correspond to a message handler overlay node, a message publisher overlay node, an encryption overlay node, an audit overlay node, an obfuscation overlay node, or the like.

An overlay node, such as the non-history overlay node 412, the history overlay node 414, and the history overlay node 422, is a node having an overlay node type (alternatively referred to as an overlay type) assigned to its node type. As shown in FIG. 4B, the overlay node 412 has the non-history overlay node type 416 and the overlay nodes 414 and 422 have the history overlay node type 408. In an example, the non-history overlay node 412 is the encryption overlay node, and the functionality of the data node 302 is extended to encrypt the data therein. The overlay node 414 has the history overlay node type 408 and the functionality of the data node 302 is extended to facilitate generation, maintenance, and utilization of a set of history nodes associated with the data node 302 within the executable graph-based model 100. Each history node of the set of history nodes associated with the data node 302 refers to a historical version of the data node 302. Additionally, the history overlay node 414 is configured to indicate the history depth and the history retention period associated with the data node 302. The history depth indicates a maximum number of history nodes associated with the data node 302. Further, the history retention period indicates a maximum time duration for which each history node of the set of history nodes associated with the data node 302, is retained in the overlay system 202. The history depth and the history retention period aid in the generation, maintenance, and utilization of the set of history nodes associated with the data node 302. The overlay node 422 has the history overlay node type 408 and the functionality of the non-history overlay node 412 is extended to facilitate the generation, maintenance, and utilization of a set of history nodes associated with the non-history overlay node 412 within the executable graph-based model 100. The history overlay node 422 may be similar to the history overlay node 414.

It will be apparent to a person skilled in the art that the list of overlay types is not exhaustive and the number of different overlay types that can be realized is not limited. Because an overlay node is itself a node, all functionality of a node described in relation to the data node 302 is thus applicable to an overlay node. For example, an overlay node includes a unique ID, a name, etc., can have attributes (e.g., an overlay node can have its data defined), supports multiple inheritance, and can be configured via node configurations. Furthermore, because an overlay node is a node, the overlay node can have one or more overlay nodes associated therewith (e.g., the history overlay node 422 is an overlay of the non-history overlay node 412). Moreover, the processing functionality of an overlay node extends to the node type of the node to which the overlay node is applied.

An overlay node, such as the overlay node 406, the overlay node 412, the overlay node 414, and the overlay node 422, is not bound to a single executable node or a single executable graph-based model (unlike nodes that have non-overlay node types). This allows overlay nodes to be centrally managed and reused across multiple instances of executable graph-based models. Notably, a node (for example, a data node, an executable node, and an overlay node) may be extended by way of overlays. Further, each overlay node may be extended to have one or more overlays. Such overlays may be termed chaining overlays.

Unlike non-overlay nodes, an overlay node includes processing logic (not shown in FIGS. 4A and 4B) which determines the functionality of the overlay node. The processing logic of an overlay node includes a block of executable code, or instructions, which carries out one or more operations associated with facilitating the generation, maintenance, and utilization of the in-situ history within the executable graph-based model 100. The block of executable code is pre-compiled code, code that requires interpretation at run-time, or a combination of both. Different overlay nodes provide different processing logic to realize different functionality.

The overlay manager 410 of the second executable node 409 is responsible for executing all overlays registered therewith. The overlay manager 410 also coordinates the execution of all associated overlay nodes. As shown in FIG. 4B, the second executable node 409 associates the data node 302 with two overlay nodes that is the overlay node 412 and the overlay node 414. Thus, the overlay manager 410 employs a strategy to manage the potentially cascading execution flow. Example strategies to manage the cascading execution of overlays include the visitor pattern and the pipe and filter pattern. Further examples include strategies that apply either depth-first or breadth-first processing patterns, a prioritization strategy, or a combination thereof. All execution strategies are defined and registered with the overlay manager 410 and are associated with an overlay via a node configuration extension for the overlay.

FIG. 5 is a block diagram 500 that illustrates a templated active node 502 within the templated version of the executable graph-based model 100, in accordance with an embodiment of the present disclosure. The templated active node 502 is shown to include an active node template 504 and an active node instance 506. The active node instance 506 is generated according to the active node template 504. The templated active node 502 shown in FIG. 5 is a compositional structure that is generated, and executed, at run-time as part of the templated version of the executable graph-based model 100. In other words, the active node template 504 is defined as “offline” and the active node instance 506 and the templated active node 502 are run-time structures that are dynamically generated during execution of the templated version of the executable graph-based model 100. The active node template 504 comprises a predetermined node structure. Further, the active node template 504 defines one or more rules that govern the generation of the active node instance 506. The active node instance 506 is an implementation of the active node template 504. In other words, the active node instance 506 is generated based on the predetermined node structure and the one or more rules of the active node template 504. The active node template 504 cannot be modified during the execution but may be modified during offline mode or at rest. During execution, only the active node instance 506 of the templated active node 502 may be modified.

The active node template 504 includes properties 508, a node template type 510, and inheritance IDs 512. The active node template 504 may optionally include attribute templates 514, metadata 516, and node configuration 518. The properties 508 of the active node template 504 include a unique ID 508a, a version ID 508b, a namespace 508c, a name 508d, and optionally include one or more icons 508e and one or more labels 508f. The inheritance IDs 512 comprise an abstract flag 520, a leaf flag 522, and a root flag 524. The node configuration 518 optionally comprises one or more node configuration strategies 526 and/or one or more node configuration extensions 528. FIG. 5 further shows a plurality of predetermined node type templates 530. The plurality of predetermined node type templates 530 includes a vertex node type template 532, an edge node type template 534, and an overlay node type template 536. Further, the active node instance 506 includes a unique ID 538, a version ID 540, and a node type instance 542. The active node instance 506 may optionally include attribute instances 544 and metadata 546. FIG. 5 further shows a plurality of predetermined node type instances 548. The plurality of predetermined node type instances 548 includes a vertex node type instance 550, an edge node type instance 552, and an overlay node type instance 554.

The unique ID 508a is unique for each active node template within the templated version of the executable graph-based model 100. Similarly, the unique ID 538 is unique for each active node instance within the templated version of the executable graph-based model 100. The unique ID 508a and the unique ID 538 are used to register, manage, and reference the active node template 504 and the active node instance 506, respectively, within the overlay system 202. The version ID 508b of the active node template 504 is incremented when the active node template 504 undergoes transactional change. Similarly, the version ID 540 of the active node instance 506 is incremented when the active node instance 506 undergoes transactional change. The namespace 508c of the active node template 504, along with the name 508d of the active node template 504, is used to help organize active node templates within the templated version of the executable graph-based model 100. That is, the active node template 504 is assigned a unique name 508d within the namespace 508c such that the name 508d of the active node template 504 need not be unique within the entire executable graph-based model 100, only within the context of the namespace 508c to which the active node template 504 is assigned. The active node template 504 optionally comprises one or more icons 508c which are used to provide a visual representation of the active node template 504. The one or more icons 508e can include icons at different resolutions and display contexts such that the visualization of the node is adapted to different display settings and contexts. The node template 504 also optionally comprises one or more labels 508f which are used to override the name 508d when the active node template 504 is rendered or visualized.

The active node template 504 supports the software development feature of multiple inheritance by maintaining references (not shown) to zero or more other active node templates, which then act as the base of the active node template 504. This allows the behavior and functionality of an active node template to be extended or derived from one or more other active node templates within an executable graph-based model. The active node instance 506 likewise supports multiple inheritance because it is an instance representation of the active node template 504. The multiple inheritance structure of the active node instance 506 is, however, limited to the corresponding instance realization of the multiple inheritance structure defined by the active node template 504, i.e., one active node instance 506 is created and managed for each active node template 504 defined in the inheritance hierarchy for an active node instance of an active node template. The inheritance IDs 512 of the active node template 504 provide an indication of the inheritance-based information, which is applicable, or can be applicable, to the active node template 504. The inheritance IDs 512 comprise a set of Boolean flags which identify the inheritance structure of the active node template 504. The abstract flag 520 of the inheritance IDs 512 allows the active node template 504 to support the construct of abstraction. When the abstract flag 520 takes a value of ‘true’, the active node template 504 is flagged as abstract meaning that it cannot be instantiated or created within an executable graph-based model. Thus, an active node template having the abstract flag 520 set to ‘true’ can only form the foundation of another active node template that inherits from it. By default, the abstract flag 520 of an active node template is set to ‘false’. The leaf flag 522 of the inheritance IDs 512 is used to indicate whether any other active node template can inherit from the active node template 504. If the leaf flag 522 is set to ‘true’, then no other active node template can inherit from the active node template 504 (but unlike an abstract node, a node template with a leaf flag set can still be instantiated and created within an executable graph-based model). The root flag 524 of the inheritance IDs 512 is used to indicate whether the active node template 504 inherits from any other active node template. If the root flag 524 is set to ‘true’, then the active node template 504 does not inherit from any other active node template. The active node template 504 is flagged as leaf (i.e., the leaf flag 522 is set to ‘true’) and/or root (i.e., the root flag 524 is set to ‘true’), or neither (i.e., both the leaf flag 522 and the root flag 524 are set to ‘false’). It will be apparent to the person skilled in the art that an active node template cannot be flagged as both abstract and leaf (i.e., the abstract flag 520 cannot be set to ‘true’ whilst the leaf flag 522 is set to ‘true’).

All elements within the templated version of the executable graph-based model 100 are defined as active node templates or active node instances. The functionality of the active node template 504 and the active node instance 506 are realized due to the use of the node type template 510 and the node type instance 542. The node type template 510 of the active node template 504 is used to extend the functionality of the active node template 504 by defining the standard set of capabilities, including data and associated behavior. The vertex node type template 532 (also referred to as a data node type) includes a template of common data structures and functionality related to the ‘things’ modeled in the graph (e.g., the data). The vertex node instance 550 includes the common data structures and functionality related to the ‘things’ modeled in the graph based on the vertex node type template 532. The edge node type template 534 includes a template of common data structures and functionality related to joining two or more nodes. A node instance having the edge node type instance 552 may connect two or more nodes and thus the edge node type instance 552 constructs associations and connections between nodes (for example objects or ‘things’) within the templated version of the executable graph-based model 100. The edge node type instance 552 is not restricted to the number of nodes that can be associated or connected by a node having the edge node type instance 552. The data structures and functionality of the edge node type instance 552 thus define a hyper-edge which allows two or more nodes to be connected through a defined set of roles. A role defines a connective relationship between the two or more nodes, and hence, allows an edge node to connect two or more nodes such that the two or more nodes may have more than one relationship therebetween. The plurality of predetermined node type templates 530 further includes the overlay node type template 536. The overlay node type template 536 is used to extend the functionality of a node template, such as the active node template 504, to incorporate processing logic. Similarly, the overlay node type instance 554 is used to extend the functionality of a node instance, such as the active node instance 506, to incorporate processing logic.

The attribute templates 514 correspond to the data defined by the active node template 504. For example, the attribute templates 514 may define the names and value types (e.g., integer, string, float, etc.) of one or more attributes but not the values of these attributes. The values of the attribute templates 514 may be defined by attribute instances 544 of the node instance 506 through one or more values or instance values. For example, the active node template 504 may define a string attribute “surname” and a corresponding active node instance 506 may assign the instance value “Bell-Richards” to this string attribute. Each attribute instance is associated with an attribute template. The active node template 504 may define one or more default values for the attribute templates 514. The default values correspond to the values that the attributes take if no value is assigned. The metadata 516 (e.g., data stored as a name, value type, and value triplet) is associated with either the active node template 504 or one or more of the attribute templates 514 of the active node template 504. Similarly, the active node instance 506 also optionally comprises the metadata 546 (e.g., data stored as a name, value type, and value triplet) which is associated with either the active node instance 506 or one or more of the attribute instances 544.

The node configuration 518 provides a high degree of configurability for the different elements of an active node template and/or an active node instance. An example of a concrete node configuration strategy is an ID strategy, associated with the configuration of the unique ID 508a of the active node template 504. A further example of a concrete node configuration strategy is a versioning strategy, associated with the configuration of the version ID 508b of the active node template 504 which supports major and minor versioning (depending on the type of transactional change incurred). The versioning strategy may be adapted to a native filing system of a user device hosting the overlay system 202 or a third-party data storage (for example, Snowflake®, or the like) associated with the overlay system 202.

A set of history overlay nodes (not shown) is associated with the templated active node 502. As the set of history overlay nodes is associated with the templated active node 502, the templated active node 502 is executable at runtime. The set of history overlay nodes is configured to facilitate the generation, maintenance, and utilization of in-situ history associated with the templated active node 502. The set of history overlay nodes includes a template history overlay node and an instance history overlay node. The template history overlay node comprises a first history overlay node template and a first history overlay node instance. Similarly, the instance history overlay node includes a second history overlay node template and a second history overlay node instance. The first history overlay node instance and the second history overlay node instance are implementations of the first history overlay node template, and the second history overlay node template, respectively. In particular, the template history overlay node is an overlay of the active node template 504 and thus facilitates the generation, maintenance, and utilization of in-situ history associated with the active node template 504. Similarly, the instance history overlay node is an overlay of the active node instance 506 and thus facilitates the generation, maintenance, and utilization of in-situ history associated with the active node instance 506.

Although it is provided that the active node template 504 is associated with the active node instance 506, the scope of the present disclosure is not limited to it. In other embodiments, the active node template 504 may be further associated with two or more active node instances where the two or more active node instances correspond to two or more implementations of the active node template 504.

FIG. 6 is a block diagram 600 that illustrates a composition of the first executable node 402 that enables persistent storage of data and the processing logic associated therewith, in accordance with an embodiment of the present disclosure.

As described in conjunction with FIG. 4A, the first executable node 402 includes the first active node 302 and the overlay node 406. The first executable node 402 has a first state 602 having a first ID 604. The first active node 302 has a second state 606 having a second ID 608, and the overlay node 406 has a third state 610 having a third ID 612. A manifest (for example, first through third manifests 614-618) is generated for each of the first active node 302, the first executable node 402, and the overlay node 406. In an embodiment, the manifests may be generated by the storage management module 218. The first manifest 614 is associated with the first executable node 402 and has a fourth ID 620 and an overlay ID 622. The second manifest 616 is associated with the active node 302 and has a fifth ID 624. The third manifest 618 associated with the overlay node 406 and has a sixth ID 626. Further, the manifests are stored at respective storage locations that may be centralized or distributed storage locations associated with the overlay system 202. The manifests may be stored by the storage management module 218.

The first state 602 of the first executable node 402 includes data required to reconstruct the first executable node 402 (e.g., attributes, properties, etc.). The first state 602 of the first executable node 402 is persistently stored along with the first ID 604. The first manifest 614 is generated for the first executable node 402 and has (i) the fourth ID 620 (which is the same as the first ID 604), (ii) the storage location of the first state 602 of the first executable node 402, and (iii) the overlay ID 622. Notably, the fourth ID 620 is the same as the first ID 604 and the fifth ID 624, hence, the first manifest 614 includes the ID of the state of the first active node 302 and the first executable node 402. Further, the overlay ID 622 is the same as the sixth ID 626 of the state of the overlay node 406. Therefore, the first manifest 614 may be used to identify and retrieve the states of the first active node 302, the first executable node 402, and the overlay node 406. Subsequently, the retrieved states may be used to reconstruct the first executable node 402 and the overlay node 406. In an instance, the first executable node 402 may be further extended to include additional overlay nodes. In such an instance, the first manifest 614 may include state IDs of the additional overlay nodes as well. A first manifest state (not shown) is then generated for the first manifest 614 and persistently stored along with the fourth ID 620.

The second state 606 of the first active node 302 includes data required to reconstruct the first active node 302 (e.g., attributes, properties, etc.) and is persistently stored along with the second ID 608. The second manifest 616 is generated for the first active node 302 and has (i) the fifth ID 624 and (ii) the storage location of the second state 606 of the first active node 302. The second ID 608 of the second state 606 and the fifth ID 624 of the second manifest 616 are the same as the first ID 604 of the first state 602 of the first executable node 402 (which is also the same as the fourth ID 620 of the first manifest 614 of the first executable node 402). As mentioned above, along with the first state 602, the first manifest 614 may also be used to identify and retrieve the second manifest 616 which in turn may be used to identify the second state 606 of the first active node 302. A second manifest state (not shown) is then generated for the second manifest 616 and persistently stored along with the fifth ID 624. Thus, the states, manifests, and manifest states for the first executable node 402 and the first active node 302 include the same, shared, ID. A shared ID can be used in this instance because the states, manifests, and manifest states are stored separately. The separate storage of the states, manifests, and manifest states exhibit a distributed architecture of the overlay system 202.

The third state 610 of the overlay node 406 includes data required to reconstruct the overlay node 406 (e.g., attributes, properties, processing logic, etc.) and is persistently stored along with the third ID 612. The third manifest 618 is generated for the overlay node 406 and includes the sixth ID 626, which is the same as the third ID 612. Therefore, the first manifest 614 may be further used to identify and retrieve the third manifest 618 which in turn may be used to identify and retrieve the third state 610 of the overlay node 406. A third manifest state (not shown) is then generated for the third manifest 618 and is persistently stored along with the sixth ID 626.

In operation, when the first executable node 402 is to be loaded, the transaction module 208, in conjunction with the storage management module 218, may execute one or more operations to retrieve the first manifest state stored at a known storage location. Based on the first manifest state, the storage management module 218 may re-construct the first manifest 614 which includes the fourth ID 620 which is the same as the fifth ID 624 of the second manifest 616. Based on the fifth ID 624, the storage management module 218 may identify the second manifest state and may generate the second manifest 616 based on which the second state 606 is identified. Subsequently, the first active node 302 is loaded and the storage management module 218 may determine that the first active node 302 is a node with overlay. Based on the fourth ID 620 (that is the same as the first ID 604 of the first state 602 of the first executable node 402) of the first manifest 614, the first state 602 is identified and retrieved. Subsequently, the first executable node 402 is loaded. Moreover, based on the overlay ID 622 (that is the same as the sixth ID 626 of the third manifest 618) of the first manifest 614, the third manifest state is identified and the third manifest 618 is generated. Subsequently, based on the sixth ID 626 (that is the same as the third ID of the third state) of the third manifest 618, the third state 610 is identified and retrieved. Based on the third state 610, the overlay node 406 is reconstructed and loaded in the executable graph-based model 100.

In some embodiments, the overlay node 406 may not be loaded in case it is not required for executing the operation associated with the set of stimuli 230. The loaded first executable node 402 and the overlay node 406 may be unloaded in case they remain unused for a first predefined time period, whereas one or more executable nodes that are used at least once during the predefined time period may be permanently loaded in the executable graph-based model 100. In some embodiments, the data and processing logic associated with a loaded executable node and/or overlay node may be transferred to a local memory of the overlay system 202 if the data and the processing logic remain unused for a second predefined time period. Further, the data and the processing logic associated with the executable node/overlay node are transferred to an external storage from the local memory in case the executable node/overlay node remains unused for a third predefined time period. The third predefined time period is greater than the second predefined time period. The term unloading refers to storing a state of a node with a current version of data and processing logic associated therewith at a storage location that is pointed by the corresponding manifest.

Although FIG. 6 illustrates the composition of the first executable node 402 that enables persistent storage of data and the processing logic associated therewith, the scope of the present disclosure is not limited to it. In other embodiments, the second executable node 409, and the templated active node 502 associated with the set of history overlay nodes may have a similar composition that enables persistent storage of data and the processing logic associated therewith.

FIGS. 7A-7D are schematic diagrams 700A-700D that, collectively, illustrate the generation, maintenance, and utilization of in-situ history in the executable graph-based model 100, in accordance with an embodiment of the present disclosure.

Referring to FIG. 7A, the executable graph-based model 100 at a first-time instance is shown. The first-time instance is hereinafter referred to as ‘T1’. The executable graph-based model 100 includes the first active node 302 and the history overlay node 406 associated therewith. The first active node 302 may be created by the controller module 206 prior to T1. The first active node 302 may be created by the controller module 206 upon reception of a stimulus that indicates the creation of an active node. Similarly, the history overlay node 406 is created based on another stimulus that indicates the creation of a history overlay node. The history overlay node 406 is created after the creation of the first active node 302 and prior to T1. The first active node 302 corresponds to a first active version of a node. Thus, the version ID of the first active node 302 is ‘1’. The history overlay node 406 is an overlay of the first active node 302. The first active node 302 is represented in the executable graph-based model 100 by way of two concentric circles, with the inner circle representing the first active node 302 and the outer circle indicating the presence of a history overlay node for extending the functionalities of the first active node 302. In such a scenario, the association of the first active node 302 with the history overlay node 406 is represented by an arrow linking the outer circle of the first active node 302 to the history overlay node 406. Similarly, the history overlay node 406 is represented in the executable graph-based model 100 by way of a single circle as it is not extended further using overlays.

FIG. 7A is further shown to include a layered architecture of the executable graph-based model 100 at T1. The layered architecture of the executable graph-based model 100 is shown to include a first version plane 702 at T1. As illustrated in FIG. 7A, at T1, the first active node 302 and the history overlay node 406 are present in the first version plane 702.

The stimuli management module 212 receives a first stimulus via the network 232. The first stimulus corresponds to a command and is associated with a first context. The context module 210, in conjunction with the stimuli management module 212, identifies that the first stimulus is directed to the first active node 302. Further, the controller module 206 and the history management module 222, collectively, execute an operation associated with the first stimulus using the first active node 302.

Referring to FIG. 7B, the executable graph-based model 100 at a second-time instance (e.g., post the execution of the operation associated with the first stimulus) is illustrated. The second time instance is hereinafter referred to as ‘T2’. Upon the identification that the first stimulus is directed to the first active node 302, the context module 210, in conjunction with the stimuli management module 212, identifies that the first active node 302 has the history overlay node 406 as the overlay. The history overlay node 406 has processing logic that facilitates the creation and maintenance of a set of history nodes associated with the first active node 302. As a result, the history management module 222 creates a clone of the first active node 302 (e.g., a cloned first active node). The clone of the first active node 302 is hereinafter referred to as a “third active node 704”. Further, the history management module 222 transfers the history overlay node 406 to the third active node 704. The transfer of the history overlay node 406 to the third active node 704 results in the conversion of the first active node 302 into a first history node 706. In other words, the first history node 706 is a version of the first active node 302 at an instance (such as T1) when the first stimulus is received. Further, the controller module 206 mutates the third active node 704 during the execution of the operation associated with the first stimulus. The first active node 302 is a data node. Thus, the mutation of the third active node 704 (e.g., the clone of the first active node 302) corresponds to the modification of the data associated with the third active node 704. The third active node 704 thus corresponds to a second active version of the first active node 302 upon the mutation of the clone thereof. Thus, the version ID of the third active node 704 is ‘2’. However, the unique ID of the third active node 704 is the same as the unique ID of the first active node 302. Further, the history overlay node 406 is an overlay of the third active node 704.

The executable graph-based model 100 is further shown to include a history edge node 708 that is configured to couple the first history node 706 to the third active node 704. Further, role nodes 710 and 712 are associated with the history edge node 708. The role node 710 defines a relationship between the history edge node 708 and the first history node 706. Similarly, the role node 712 defines the relationship between the history edge node 708 and the third active node 704. For example, the role node 710 defines that the first history node 706 corresponds to a previous version of a node and the role node 712 defines that the third active node 704 corresponds to a next version of the node.

FIG. 7B is further shown to include the layered architecture of the executable graph-based model 100 at T2. The layered architecture of the executable graph-based model 100 includes the first version plane 702 and a second version plane 718 at T2. As illustrated in FIG. 7B, the first history node 706 is present in the first version plane 702, whereas the third active node 704 and the history overlay node 406 are present in the second version plane 718. Further, the history edge node 708 couples the first version plane 702 to the second version plane 718. The layered architecture of the executable graph-based model 100 at T2 thus illustrates that the third active node 704 and the first history node 706 are different node versions. Although not shown, the executable graph-based model 100 may include various active and history nodes present in different version planes. The arrangement of the nodes in version planes enables all the nodes on one version plane to be loaded or unloaded simultaneously.

At T2, the stimuli management module 212 is configured to receive a second stimulus. The second stimulus corresponds to a command and is associated with a second context. Further, the context module 210, in conjunction with the stimuli management module 212, identifies that the second stimulus is directed to the third active node 704. Further, the controller module 206 and the history management module 222, collectively, execute an operation associated with the second stimulus using the third active node 704.

Referring to FIG. 7C, the executable graph-based model 100 at a third-time instance (i.e., post the execution of the operation associated with the second stimulus) is illustrated. The third time instance is hereinafter referred to as ‘T3’.

Upon the identification that the second stimulus is directed to the third active node 704, the history management module 222 identifies that the third active node 704 has the history overlay node 406 as the overlay. As the history overlay node 406 is associated with the third active node 704, the history management module 222 creates a clone of the third active node 704 (e.g., a cloned third active node). The clone of the third active node 704 is hereinafter referred to as a “fourth active node 720”. Further, the history management module 222 transfers the history overlay node 406 to the fourth active node 720. In other words, the history management module 222 delinks the history overlay node 406 from the third active node 704 and links the history overlay node 406 to the clone of the third active node 704 (e.g., the fourth active node 720). The transfer of the history overlay node 406 to the fourth active node 720 results in a conversion of the third active node 704 into a second history node 722. Further, the controller module 206 mutates the fourth active node 720 during the execution of the operation associated with the second stimulus. The third active node 704 is a data node. Thus, the mutation of the clone of the third active node 704 (e.g., the fourth active node 720) corresponds to the modification of the data associated with the fourth active node 720. The fourth active node 720 thus corresponds to a third active version of the first active node 302. Consequently, the version ID of the fourth active node 720 is ‘3’. However, the unique ID of the fourth active node 720 is the same as the unique ID of the first active node 302 and the third active node 704. Further, the history overlay node 406 is an overlay of the fourth active node 720.

The executable graph-based model 100 is further shown to include a history edge node 724 that is configured to couple the second history node 722 to the fourth active node 720. Further, role nodes 726 and 728 are associated with the history edge node 724. The role node 726 defines a relationship between the history edge node 724 and the second history node 722. Similarly, the role node 728 defines the relationship between the history edge node 724 and the fourth active node 720. For example, the role node 726 defines that the second history node 722 corresponds to a previous version of a node and the role node 728 defines that the fourth active node 720 corresponds to a next version of the node. Further, role nodes 730 and 732 are associated with the history edge nodes 708 and 724. The role node 730 defines that the history edge node 708 corresponds to a previous history edge node and the role node 732 defines that the history edge node 724 corresponds to a next history edge node.

FIG. 7C is further shown to include the layered architecture of the executable graph-based model 100 at T3. The layered architecture of the executable graph-based model 100 includes the first version plane 702, the second version plane 718, and a third version plane 734, at T3. As illustrated in FIG. 7C, the first history node 706 is present in the first version plane 702, the second history node 722 is present in the second version plane 718, and the fourth active node 720, along with the history overlay node 406, is present in the third version plane 734. Further, the history edge node 708 couples the first version plane 702 to the second version plane 718, whereas the history edge node 724 couples the second version plane 718 to the third version plane 734.

At T3, the stimuli management module 212 is configured to receive a third stimulus. The third stimulus corresponds to a command and is associated with a third context. The first through third stimuli constitute the set of stimuli 230. Similarly, the first through third contexts constitute the set of contexts 226. The context module 210, in conjunction with the stimuli management module 212, identifies that the third stimulus is directed to the fourth active node 720. Further, the context module 210, in conjunction with the stimuli management module 212 and the history management module 222, identifies that the first history node 706 and the second history node 722 are required for the execution of an operation associated with the third stimulus, based on the third context. Consequently, the history management module 222, in conjunction with the controller module 206, identifies the fourth active node 720, the first history node 706, and the second history node 722. The first and second history nodes 706 and 722 are identified by traversing the history edge nodes 724 and 708 from the fourth active node 720. Further, the controller module 206 and the history management module 222, collectively, execute an operation associated with the third stimulus based on the fourth active node 720, the history overlay node 406, the first history node 706, and the second history node 722.

Referring to FIG. 7D, the executable graph-based model 100 at a fourth-time instance (i.e., post the execution of the operation associated with the third stimulus) is illustrated. The fourth time instance is hereinafter referred to as ‘T4’. Upon the identification that the third stimulus is directed to the fourth active node 720, the history management module 222 identifies that the fourth active node 720 has the history overlay node 406 as the overlay. As the history overlay node 406 is associated with the fourth active node 720, the history management module 222 creates a clone of the fourth active node 720. The clone of the fourth active node 720 is hereinafter referred to as a “fifth active node 736”. Further, the history management module 222 transfers the history overlay node 406 to the fifth active node 736. The transfer of the history overlay node 406 to the fifth active node 736 results in the conversion of the fourth active node 720 into a third history node 738. Further, the controller module 206 mutates the fifth active node 736 based on the first and second history nodes 706 and 722, during the execution of the operation associated with the third stimulus. Each of the fourth and fifth active nodes 720 and 736 corresponds to a data node. Thus, the mutation of the fifth active node 736 corresponds to a modification of the data associated therewith. Upon mutation, the fifth active node 736 corresponds to a fourth active version of the first active node 302. Thus, the version ID of the fifth active node 736 is ‘4’. However, the unique ID of the fifth active node 736 is the same as the unique ID of the first active node 302, the third active node 704, and the fourth active node 720. Further, the history overlay node 406 is an overlay of the fifth active node 736. Additionally, the fifth active node 736 is mutable, whereas each history node is immutable.

The executable graph-based model 100 is further shown to include a history edge node 740 that is configured to couple the third history node 738 to the fifth active node 736. Further, role nodes 742 and 744 are associated with the history edge node 740. The role node 742 defines a relationship between the history edge node 740 and the third history node 738. Similarly, the role node 744 defines the relationship between the history edge node 740 and the fifth active node 736. For example, the role node 742 defines that the third history node 738 corresponds to a previous version of a node and the role node 744 defines that the fifth active node 736 corresponds to a next version of the node. Further, role nodes 746 and 748 are associated with the history edge nodes 724 and 740. The role node 746 defines that the history edge node 724 corresponds to a previous history edge node and the role node 748 defines that the history edge node 740 corresponds to a next history edge node. Thus, the operation associated with the third stimulus is further based on the history edge nodes 708, 724, and 740. In an embodiment, the executable graph-based model 100 further includes role nodes 750 and 752 that are associated with the history edge nodes 708 and 740. The role node 750 defines that the history edge node 708 corresponds to the earliest history edge node and the role node 752 defines that the history edge node 740 corresponds to a latest history edge node. In an example, the stimuli management module 212 receives another stimulus (e.g., different from the first through third stimuli) that is directed to the fifth active node 736 and indicates the requirement of the first history node 706 for stimulus processing. In such an example, the history management module 222, in conjunction with the controller module 206, may traverse from the fifth active node 736 to the first history node 706 via the history edge nodes 740 and 708 by utilizing the role node 750. Beneficially, such traversal is performed in a manner that is optimal and significantly reduces the time and processing complexity required for the identification of the first history node 706.

Thus, at T4, the executable graph-based model 100 includes a set of history nodes that is associated with the fifth active node 736, where the set of history nodes includes the first through third history nodes 706, 722, and 738. The executable graph-based model 100 further includes a set of history edge nodes that is associated with the fifth active node 736, where the set of history edge nodes includes the history edge nodes 708, 724, and 740. Further, each history edge node is coupled to one or more remaining history edge nodes by way of one or more role nodes. The history edge nodes and the role nodes enable optimal traversal in the executable graph-based model 100.

Although FIGS. 7A-7D describe that each history edge node is associated with either two or four role nodes, the scope of the present disclosure is not limited to it. In other embodiments, each history edge node may be associated with any number of role nodes.

FIG. 7D is further shown to include the layered architecture of the executable graph-based model 100 at T4. The layered architecture of the executable graph-based model 100 includes the first version plane 702, the second version plane 718, the third version plane 734, and a fourth version plane 754 at T4. As illustrated in FIG. 7D, the first history node 706 is present in the first version plane 702, the second history node 722 is present in the second version plane 718, the third history node 738 is present in the third version plane 734, and the fifth active node 736 and the history overlay node 406 are present in the fourth version plane 754. Further, the history edge node 708 couples the first version plane 702 to the second version plane 718, the history edge node 724 couples the second version plane 718 to the third version plane 734, and the history edge node 740 couples the third version plane 734 to the fourth version plane 754.

Although not shown, each version plane of the layered architecture of executable graph-based model 100 includes multiple nodes. The arrangement of the nodes in version planes enables all the nodes on one version plane to be loaded or unloaded simultaneously. For example, the history management module 222, in conjunction with the data management module 236, may be configured to load any of the first through fourth version planes 702, 718, 734, and 754 into the executable graph-based model 100 for stimulus processing. Similarly, the history management module 222, in conjunction with the data management module 236, may be configured to unload any of the first through fourth version planes 702, 718, 734, and 754 from the executable graph-based model 100 when the same is not in use. Thus, the storage in the overlay system 202 is optimized.

In some examples, the processing of each stimulus of the set of stimuli 230 results in the generation, maintenance, and utilization of in-situ history that further results in one or more outcomes being generated (e.g., the outcome 234). Such outcomes are either handled internally by one or more modules in the overlay system 202 or communicated via the interface module 204 as an external outcome. In one embodiment, all stimuli and corresponding outcomes are recorded for auditing and post-processing purposes by, for example, an operations module (not shown) and/or an analytics module (not shown) of the overlay system 202.

In some embodiments, the history management module 222 may be further configured to delete one or more history nodes associated with an active node based on the historical depth associated therewith. For example, the history overlay node 406 associated with the fifth active node 736 indicates the history depth and the maximum retention period associated with the fifth active node 736. The history depth indicates a maximum number of historical versions of an active node (e.g., the first active node 702) that may be generated and maintained in the overlay system 202. Further, the history retention period indicates a maximum time duration for which each historical version may be retained in the overlay system 202. Thus, in one embodiment, the history management module 222 may be configured to delete the first history node 706 from the overlay system 202 based on the version ID of the fifth active node 736 being greater than the history depth indicated in the history overlay node 406. In another embodiment, the history management module 222 may be further configured to delete one or more history nodes of the first set of history nodes based on the history retention period associated with the fifth active node 736. For example, the processing circuitry deletes the first history node 706 from the overlay system 202 based on a lapse of the history retention period indicated in the history overlay node 406.

In the present disclosure, data and processing logic are stored separately to ensure segregation and independent control thereof. Therefore, prior to the execution of the operation associated with the first stimulus, the data management module 236 in conjunction with the overlay management module 214, may be configured to determine that at least one of the first active node 302 and the history overlay node 406 that are required for executing the operation associated with the first stimulus, are currently not loaded in the executable graph-based model 100. Thus, the data management module 236 in conjunction with the overlay management module 214, is configured to load the nodes that are currently not loaded, in the executable graph-based model 100, with corresponding data and processing logic. Similarly, prior to the execution of the operation associated with the second stimulus, the data management module 236 in conjunction with the overlay management module 214, may be configured to load, in the executable graph-based model 100 with corresponding data and processing logic, at least one of the third active node 704, the first history node 706, the history overlay node 406, and the history edge node 708 that are to be utilized for processing of the second stimulus. Additionally, prior to the execution of the operation associated with the third stimulus, the data management module 236, in conjunction with the overlay management module 214, may be configured to load, in the executable graph-based model 100 with corresponding data and processing logic, at least one of the fourth active node 720, the first history node 706, the second history node 722, the history overlay node 406, the history edge node 708, and the history edge node 724. The loading operation may be performed similarly as described in FIG. 6.

In the present disclosure, each history node is indicative of a timestamp at which the corresponding history node is created. Further, the history management module 222 may be configured to create a plurality of previous versions of the executable graph-based model based on the timestamp associated with each history node.

Although it is described that at each time instance, the executable graph-based model 100 includes a single active node, the scope of the present disclosure is not limited to it. In other embodiments, at each time instance, the executable graph-based model 100 may include a plurality of active nodes (e.g., the first and second active nodes 302 and 418), without deviating from the scope of the present disclosure. In such a scenario, the executable graph-based model 100 may further include a plurality of history nodes, a plurality of history overlay nodes, and a plurality of history edge nodes associated with the plurality of active nodes. In such embodiments, each active node is associated with a set of history nodes, a set of history overlay nodes, and a set of history edge nodes. The set of history nodes corresponds to historical versions of the corresponding active node. Additionally, the set of history overlay nodes is configured to facilitate the generation and maintenance of the set of history nodes associated with the corresponding active node.

Although FIGS. 7A-7D, collectively, illustrate the generation, maintenance, and utilization of the history nodes associated with the fifth active node 736, the scope of the present disclosure is not limited to it. In other embodiments, history nodes (e.g., fourth and fifth history nodes (not shown)) associated with the second active node 418 may be generated, maintained, and utilized in the overlay system 202 in a similar manner. In such embodiments, the history nodes may be created upon reception of the set of stimuli 230 by the stimuli management module 212. Further, the stimuli management module 212 receives a fourth stimulus. The fourth stimulus is associated with a fourth context. The context module 210, in conjunction with the stimuli management module 212, identifies that the fourth stimulus is directed to the second active node 418 and indicates a requirement of the fourth and fifth history nodes for the execution of an operation associated with the fourth stimulus. In such a scenario, the history management module 222 identifies the second active node 418 in the executable graph-based model 100 and creates a cloned second active node (not shown). Further, the history management module 222 transfers the history overlay nodes 414 and 422 from the second active node 418 to the cloned second active node, and the cloned second active node is mutated based on the fourth and fifth history nodes to execute the operation associated with the fourth stimulus. The mutation of the cloned second active node corresponds to at least one of a group consisting of modification of data associated with the data node 302, modification of data associated with the non-history overlay node 412, and modification of processing logic associated with the non-history overlay node 412.

The scope of the present disclosure is not limited to in-situ history for non-templated active nodes. In some embodiments, when the executable graph-based model 100 is templated, history nodes (e.g., sixth and seventh history nodes (not shown)) associated with the templated active node 502 may be generated, maintained, and utilized in the overlay system 202. The sixth and seventh history nodes may be created upon reception of the set of stimuli 230 by the stimuli management module 212. The history management module 222 may create the sixth and seventh history nodes based on the set of stimuli 230. Further, the stimuli management module 212 receives a fifth stimulus that is associated with a fifth context. The context module 210, in conjunction with the stimuli management module 212, identifies that the fifth stimulus is directed to the templated active node 502 and indicates a requirement of the sixth and seventh history nodes for the execution of an operation associated with the fifth stimulus. In such a scenario, the history management module 222 identifies the templated active node 502 in the templated version of the executable graph-based model 100 and creates a clone of the templated active node 502. Further, the history management module 222 transfers the instance history overlay node and the template history overlay node from the templated active node 502 to the clone of the templated active node 502. Further, the clone of the templated active node 502 is mutated based on the sixth and seventh history nodes, to execute the operation associated with the fifth stimulus. The mutation of the clone of the templated active node 502 corresponds to at least one of a group consisting of modification of the corresponding active node template and the corresponding active node instance.

The scope of the present disclosure is not limited to the fifth active node 736 being associated with a single history overlay node (e.g., the history overlay node 406). In other embodiments, the fifth active node 736 may be further associated with one or more overlay nodes such as an encryption overlay node, an obfuscation overlay node, a message handler overlay node, a message publisher overlay node, or the like, without deviating from the scope of the present disclosure.

In some embodiments, the history overlay node 406 may also be associated with one or more non-history overlay nodes such as an encryption overlay node, an obfuscation overlay node, a message handler overlay node, a message publisher overlay node, or the like. Similarly, each history node may be associated with any of the afore-mentioned non-history overlay nodes. For example, when the data in a history node (such as the first history node 706) contains PII or PHI, such a history node is extended by an encryption overlay node to encrypt the PII or PHI contained in the history node.

In some embodiments, at least one of the modules of the overlay system 202 except for the executable graph-based model 100 may form the processing circuitry that executes the operations associated with the generation, maintenance, and utilization of in-situ history within the overlay system 202.

In FIGS. 7A-7D, various role nodes (such as role nodes 710, 712, 726, 728, 730, 732, 742, 744, 746, 748, 750, and 752) are not shown in the form of nodes (i.e., circles), and instead are shown as arrows to keep the illustration concise and clear, and should not be considered a limitation of the present disclosure. Additionally, in some embodiments, role nodes may be included in the corresponding edge node. For example, the role nodes 710 and 712 may be included in the history edge node 708.

FIG. 8 is a schematic diagram that illustrates an example implementation of in-situ history in an executable graph-based robotic arm model 800, in accordance with an embodiment of the present disclosure. Referring to FIG. 8, the executable graph-based robotic arm model 800 corresponds to an executable graph-based model generated for a robotic arm 802, and is hereinafter referred to as the “robotic arm model 800”. The robotic arm 802 includes various components such as a brain, a shoulder, an upper arm, a lower arm, a hand, fingers, and phalanges. In such a scenario, the robotic arm model 800 may include active nodes that represent the components of the robotic arm 802. Such active nodes are connected in a hierarchical structure. For example, the brain acts as a root, the shoulder, the upper arm, the lower arm, the hand, the fingers, and some phalanges act as intermediate nodes, and the remaining phalanges act as leaves, of the hierarchical structure of the robotic arm model 800. The root and intermediate active nodes of the hierarchical structure have the edge node type, whereas leaf active nodes of the hierarchical structure have the vertex node type. Further, the executable nodes are linked by way of nodes of role node type (depicted by way of arrows). Hereinafter, each node with the edge node type is referred to as an edge, each node with the vertex node type is referred to as a vertex, and each node with the role node type is referred to as a role.

As shown, an executable graph-based model (e.g., the robotic arm model 800) generated for the robotic arm 802 includes a brain edge 804, a shoulder edge 806, an upper arm edge 808, a lower arm edge 810, a hand edge 812, and various finger edges (for example, a finger edge 814) that represent the brain, the shoulder, the upper arm, the lower arm, the hand, and the fingers of the robotic arm 802, respectively. The robotic arm model 800 further includes various phalange edges (for example, a phalange edge 816) and various phalange vertices (for example, a phalange vertex 818) that represent the phalanges of the robotic arm 802. Phalanges that represent intermediate nodes of the hierarchical structure are edges, whereas phalanges that represent leaf nodes of the hierarchical structure are vertices. The brain edge 804 and the shoulder edge 806 are linked by way of a shoulder role. The shoulder edge 806 and the upper arm edge 808 are linked by way of an upper arm role, whereas the upper arm edge 808 and the lower arm edge 810 are linked by way of a lower arm role. Similarly, the lower arm edge 810 and the hand edge 812 are linked by way of a hand role. Further, the hand edge 812 is linked with each finger edge by way of a finger role. Each finger edge is associated with an adjacent phalange edge by way of a phalange role, two phalange edges are associated with each other by way of corresponding phalange roles, and a phalange edge and a phalange vertex are associated with each other by way of a phalange role. Various nodes of the robotic arm model 800 work in tandem to enable movement of the robotic arm 802. The vertices, edges, and role nodes of the robotic arm model 800, collectively, enable movement of the robotic arm 802.

The robotic arm 802 may be utilized for various applications such as in warehouses for performing pick and place operations, in operation theatres for performing complex surgeries, or the like. Therefore, the robotic arm 802 has to be trained rigorously to mimic the seamless motion of a human arm. Such training requires monitoring improvement in the motion of the robotic arm 802. Hence, the history associated with the nodes of the robotic arm model 800 becomes crucial for monitoring improvement in the motion of the robotic arm 802. Further, the history associated with the nodes of the robotic arm model 800 is to be processed in real-time with minimum latency for monitoring the improvement in the motion of the robotic arm 802.

Each of the brain edge 804, the shoulder edge 806, the upper arm edge 808, the lower arm edge 810, and the hand edge 812 are extended to have history overlay nodes 820-828, respectively. The history overlay nodes 820-828 facilitate the generation, maintenance, and utilization of in-situ history associated with the brain edge 804, the shoulder edge 806, the upper arm edge 808, the lower arm edge 810, and the hand edge 812, respectively. The brain edge 804, the shoulder edge 806, the upper arm edge 808, the lower arm edge 810, and the hand edge 812 correspond to active versions of the corresponding nodes at T3, as explained in FIGS. 7A-7D.

As shown, the history overlay node 820, that is associated with the brain edge 804, facilitates the generation and maintenance of brain edge history nodes 830 and 832 in the robotic arm model 800. The brain edge history nodes 830 and 832 correspond to historical versions of the brain edge 804 at previous time instances, e.g., T1 and T2, respectively. Similarly, the history overlay node 822, associated with the shoulder edge 806, facilitates the generation and maintenance of shoulder edge history nodes 834 and 836 in the robotic arm model 800. The shoulder edge history nodes 834 and 836 correspond to historical versions of the shoulder edge 806 at T1 and T2, respectively. Further, the history overlay node 824, associated with the upper arm edge 808, facilitates the generation and maintenance of upper arm edge history nodes 838 and 840 in the robotic arm model 800. The upper arm edge history nodes 838 and 840 correspond to historical versions of the upper arm edge 808 at T1 and T2, respectively. Additionally, the history overlay node 826, associated with the lower arm edge 810, facilitates the generation and maintenance of lower arm edge history nodes 842 and 844 in the robotic arm model 800. The lower arm edge history nodes 842 and 844 correspond to historical versions of the lower arm edge 810 at T1 and T2, respectively. Similarly, the history overlay node 828, associated with the hand edge 812, facilitates the generation and maintenance of hand edge history nodes 846 and 848 in the robotic arm model 800. The hand edge history nodes 846 and 848 correspond to historical versions of the hand edge 812 at T1 and T2, respectively.

Each edge is further associated with history edge nodes and role nodes to enable coupling to the history nodes. In FIG. 8, the history edge nodes are not shown, and the role nodes are shown as arrows to keep the illustration concise and clear, and should not be considered a limitation of the present disclosure. Thus, role nodes 850 and 852 couple the brain edge history node 830 to the brain edge history node 832, whereas role nodes 854 and 856 couple the brain edge history node 832 to the brain edge 804. The functionalities of the history edge nodes and the role nodes 850-856 remain the same as described in FIGS. 7A-7D. Similarly, role nodes 858 and 860 couple the shoulder edge history node 834 to the shoulder edge history node 836, whereas role nodes 862 and 864 couple the shoulder edge history node 836 to the shoulder edge 806. Further, role nodes 866 and 868 couple the upper arm edge history node 838 to the upper arm edge history node 840, whereas role nodes 870 and 872 couple the upper arm edge history node 840 to the upper arm edge 808. Role nodes 874 and 876 couple the lower arm edge history node 842 to the lower arm edge history node 844, whereas role nodes 878 and 880 couple the lower arm edge history node 844 to the lower arm edge 810. Lastly, role nodes 882 and 884 couple the hand edge history node 846 to the hand edge history node 848, whereas role nodes 886 and 888 couple the hand edge history node 848 to the hand edge 812.

The robotic arm model 800 corresponds to the executable graph-based model 100 present in the overlay system 202. In operation, the stimuli management module 212 receives a sixth stimulus. The sixth stimulus is a command. The command is associated with a sixth context. The context module 210, in conjunction with the stimuli management module 212, identifies that the sixth stimulus is directed to the brain edge 804, the shoulder edge 806, the upper arm edge 808, the lower arm edge 810, and the hand edge 812. The stimuli management module 212 further identifies that the sixth stimulus corresponds to a command that indicates a requirement to monitor improvement in the motion of the robotic arm 802.

Subsequently, the stimuli management module 212, in conjunction with the controller module 206, identifies the brain edge 804, the shoulder edge 806, the upper arm edge 808, the lower arm edge 810, and the hand edge 812, in the robotic arm model 800. Further, the stimuli management module 212, in conjunction with the controller module 206, identifies that the history overlay nodes 820-828 are associated with the brain edge 804, the shoulder edge 806, the upper arm edge 808, the lower arm edge 810, and the hand edge 812, respectively. Thus, the history management module 222, in conjunction with the controller module 206, traverses the history edge nodes and role nodes corresponding to the history overlay nodes 820-828 to identify the brain edge history nodes 830 and 832, the shoulder edge history nodes 834 and 836, the upper arm edge history nodes 838 and 840, the lower arm edge history nods 842 and 844, and the hand edge history nodes 846 and 848.

The controller module 206 then executes an operation associated with the sixth stimulus based on the identified nodes. The operation includes the identification of improvement in the performance of the robotic arm 802 from T1 to T3 or decline in the performance of the robotic arm 802 from T1 to T3. The controller module 206 further generates an outcome (such as the outcome 234). The outcome may indicate improvement in the performance of the robotic arm 802 from T1 to T3 or decline in the performance of the robotic arm 802 from T1 to T3. Thus, the in-situ history of the robotic arm model 800 is utilized. As the history associated with the robotic arm 802 and the processing logic required for monitoring the improvement in the motion of the robotic arm 802 is present in-situ in the robotic arm model 800, the latency associated with the monitoring of the improvement in the motion of the robotic arm 802 is significantly reduced (i.e., near-zero latency) in comparison to conventional techniques.

FIG. 9 shows an example computing system 900 for carrying out the methods of the present disclosure, in accordance with an embodiment of the present disclosure. Specifically, FIG. 9 shows a block diagram of an embodiment of the computing system 900 according to example embodiments of the present disclosure.

The computing system 900 may be configured to perform any of the operations disclosed herein, such as, for example, any of the operations discussed with reference to the functional modules described in relation to FIG. 2. The computing system 900 can be implemented as a conventional computer system, an embedded controller, a laptop, a server, a mobile device, a smartphone, a set-top box, a kiosk, a vehicular information system, one or more processors associated with a television, a customized machine, any other hardware platform, or any combination or multiplicity thereof. In one embodiment, the computing system 900 is a distributed system configured to function using multiple computing machines interconnected via a data network or bus system.

The computing system 900 includes computing devices (such as a computing device 902). The computing device 902 includes one or more processors (such as a processor 904) and a memory 906. The processor 904 may be any general-purpose processor(s) configured to execute a set of instructions. For example, the processor 904 may be a processor core, a multiprocessor, a reconfigurable processor, a microcontroller, a digital signal processor (DSP), an application-specific integrated circuit (ASIC), a graphics processing unit (GPU), a neural processing unit (NPU), an accelerated processing unit (APU), a brain processing unit (BPU), a data processing unit (DPU), a holographic processing unit (HPU), an intelligent processing unit (IPU), a microprocessor/microcontroller unit (MPU/MCU), a radio processing unit (RPU), a tensor processing unit (TPU), a vector processing unit (VPU), a wearable processing unit (WPU), a field programmable gate array (FPGA), a programmable logic device (PLD), a controller, a state machine, gated logic, discrete hardware component, any other processing unit, or any combination or multiplicity thereof. In one embodiment, the processor 904 may be multiple processing units, a single processing core, multiple processing cores, special purpose processing cores, co-processors, or any combination thereof. The processor 904 may be communicatively coupled to the memory 906 via an address bus 908, a control bus 910, a data bus 912, and a messaging bus 914.

The memory 906 may include non-volatile memories such as a read-only memory (ROM), a programable read-only memory (PROM), an erasable programmable read-only memory (EPROM), a flash memory, or any other device capable of storing program instructions or data with or without applied power. The memory 906 may also include volatile memories, such as a random-access memory (RAM), a static random-access memory (SRAM), a dynamic random-access memory (DRAM), and a synchronous dynamic random-access memory (SDRAM). The memory 906 may include single or multiple memory modules. While the memory 906 is depicted as part of the computing device 902, a person skilled in the art will recognize that the memory 906 can be separate from the computing device 902.

The memory 906 may store information that can be accessed by the processor 904. For instance, the memory 906 (e.g., one or more non-transitory computer-readable storage mediums, memory devices) may include computer-readable instructions (not shown) that can be executed by the processor 904. The computer-readable instructions may be software written in any suitable programming language or may be implemented in hardware. Additionally, or alternatively, the computer-readable instructions may be executed in logically and/or virtually separate threads on the processor 904. For example, the memory 906 may store instructions (not shown) that when executed by the processor 904 cause the processor 904 to perform operations such as any of the operations and functions for which the computing system 900 is configured, as described herein. Additionally, or alternatively, the memory 906 may store data (not shown) that can be obtained, received, accessed, written, manipulated, created, and/or stored. The data can include, for instance, the data and/or information described herein in relation to FIGS. 1-8. In some implementations, the computing device 902 may obtain from and/or store data in one or more memory device(s) that are remote from the computing system 900.

The computing device 902 may further include an input/output (I/O) interface 916 communicatively coupled to the address bus 908, the control bus 910, and the data bus 912. The data bus 912 and messaging bus 914 may include a plurality of tunnels that may support parallel execution of messages by the overlay system 202. The I/O interface 916 is configured to couple to one or more external devices (e.g., to receive and send data from/to one or more external devices). Such external devices, along with the various internal devices, may also be known as peripheral devices. The I/O interface 916 may include both electrical and physical connections for operably coupling the various peripheral devices to the computing device 902. The I/O interface 916 may be configured to communicate data, addresses, and control signals between the peripheral devices and the computing device 902. The I/O interface 916 may be configured to implement any standard interface, such as a small computer system interface (SCSI), a serial-attached SCSI (SAS), a fiber channel, a peripheral component interconnect (PCI), a PCI express (PCle), a serial bus, a parallel bus, an advanced technology attachment (ATA), a serial ATA (SATA), a universal serial bus (USB), Thunderbolt, FireWire, various video buses, and the like. The I/O interface 916 is configured to implement only one interface or bus technology. Alternatively, the I/O interface 916 is configured to implement multiple interfaces or bus technologies. The I/O interface 916 may include one or more buffers for buffering transmissions between one or more external devices, internal devices, the computing device 902, or the processor 904. The I/O interface 916 may couple the computing device 902 to various input devices, including mice, touch screens, scanners, biometric readers, electronic digitizers, sensors, receivers, touchpads, trackballs, cameras, microphones, keyboards, any other pointing devices, or any combinations thereof. The I/O interface 916 may couple the computing device 902 to various output devices, including video displays, speakers, printers, projectors, tactile feedback devices, automation control, robotic components, actuators, motors, fans, solenoids, valves, pumps, transmitters, signal emitters, lights, and so forth.

The computing system 900 may further include a storage unit 918, a network interface 920, an input controller 922, and an output controller 924. The storage unit 918, the network interface 920, the input controller 922, and the output controller 924 are communicatively coupled to the central control unit (e.g., the memory 906, the address bus 908, the control bus 910, and the data bus 912) via the I/O interface 916. The network interface 920 communicatively couples the computing system 900 to one or more networks such as wide area networks (WAN), local area networks (LAN), intranets, the Internet, wireless access networks, wired networks, mobile networks, telephone networks, optical networks, or combinations thereof. The network interface 920 may facilitate communication with packet-switched networks or circuit-switched networks which use any topology and may use any communication protocol. Communication links within the network may involve various digital or analog communication media such as fiber optic cables, free-space optics, waveguides, electrical conductors, wireless links, antennas, radio-frequency communications, and so forth.

The storage unit 918 is a computer-readable medium, preferably a non-transitory computer-readable medium, comprising one or more programs, the one or more programs comprising instructions which when executed by the processor 904 cause the computing system 900 to perform the method steps of the present disclosure. Alternatively, the storage unit 918 is a transitory computer-readable medium. The storage unit 918 can include a hard disk, a floppy disk, a compact disc read-only memory (CD-ROM), a digital versatile disc (DVD), a Blu-ray disc, a magnetic tape, a flash memory, another non-volatile memory device, a solid-state drive (SSD), any magnetic storage device, any optical storage device, any electrical storage device, any semiconductor storage device, any physical-based storage device, any other data storage device, or any combination or multiplicity thereof. In one embodiment, the storage unit 918 stores one or more operating systems, application programs, program modules, data, or any other information. The storage unit 918 is part of the computing device 902. Alternatively, the storage unit 918 is part of one or more other computing machines that are in communication with the computing device 902, such as servers, database servers, cloud storage, network attached storage, and so forth.

The input controller 922 may include suitable logic, circuitry, interfaces, and/or code, executable by the circuitry, that may be configured to control one or more input devices that may be configured to receive an input (the set of stimuli 230) for the overlay system 202. The output controller 924 may include suitable logic, circuitry, interfaces, and/or code, executable by the circuitry, that may be configured to control one or more output devices that may be configured to render/output the outcome of the operation executed to process the received input (the set of stimuli 230).

FIG. 10 is a flowchart 1000 that illustrates a method for facilitating in-situ history using the executable graph-based model 100, in accordance with an embodiment of the present disclosure. Referring to FIG. 10, at 1002, the processing circuitry of the overlay system 202 (e.g., the stimuli management module 212) receives a stimulus (such as the third stimulus) associated with the overlay system 202. At 1004, the processing circuitry (e.g., the context module 210, the stimuli management module 212, and the history management module 222) identifies, in the executable graph-based model 100, an active node (such as the fourth active node 720) and one or more history nodes (such as the first and second history nodes 706 and 722) associated with the active node, based on a context (such as the third context) of the stimulus (such as the third stimulus). At 1006, the processing circuitry (e.g., the controller module 206 and the history management module 222) executes the operation associated with the stimulus based on the identified active node (such as the fourth active node 720), a set of history overlay nodes (such as the history overlay node 406) associated with the fourth active node 720, and the identified one or more history nodes (such as the first and second history nodes 706 and 722).

The disclosed embodiments encompass numerous advantages including an efficient and seamless approach for facilitation of in-situ history using executable graph-based models. The systems and methods disclosed herein provide an ability to dynamically utilize the in-situ history in the executable graph-based model 100. Moreover, the disclosed system and methods may exhibit a consistent performance even with limited storage and processing resources as all the data and processing logic associated with the executable graph-based model 100 is loaded as per the requirement thereof. The systems and methods disclosed herein allow for the segregation of data and processing logic and hence ensure mutual independence thereof. Dynamic utilization of in-situ history allows for a significant reduction in latency during the execution of operations. Application areas of the systems and methods disclosed herein may include, but are not limited to, industrial processes, robotics, home security, automation industry, or the like.

Certain embodiments of the disclosure may be found in the disclosed systems, methods, and non-transitory computer-readable medium, for facilitating in-situ history in executable graph-based models. The methods and systems disclosed herein include various operations performed by the processing circuitry. The overlay system disclosed herein includes the storage element configured to store the executable graph-based model that includes the plurality of history nodes, the plurality of active nodes, and the plurality of history overlay nodes. Each active node, of the plurality of active nodes, is associated with the set of history nodes of the plurality of history nodes and the set of history overlay nodes, of the plurality of history overlay nodes. The set of history nodes corresponds to the set of historical versions of the corresponding active node. The set of history overlay nodes is configured to facilitate generation and maintenance of the set of history nodes associated with the corresponding active node. The overlay system also includes the processing circuitry that is coupled to the storage clement, and configured to receive a first stimulus associated with the overlay system. The processing circuitry is further configured to identify, in the executable graph-based model for stimulus processing, based on a first context of the first stimulus, (i) a first active node of the plurality of active nodes and (ii) one or more history nodes of a first set of history nodes associated with the first active node. Further, the processing circuitry is configured to execute an operation associated with the first stimulus based on (i) the first active node, (ii) a first set of history overlay nodes, of the plurality of history overlay nodes, associated with the first active node, and (iii) the identified one or more history nodes.

In some embodiments, the first stimulus corresponds to one of a group consisting of a query and a command.

In some embodiments, the executable graph-based model further includes a plurality of history edge nodes. Each active node is further associated with a set of history edge nodes, of the plurality of history edge nodes, such that each history edge node couples one history node to one of a group consisting of another history node and the corresponding active node and is indicative of an association therebetween. the processing circuitry further executes the operation associated with the first stimulus based on one or more history edge nodes associated with the first active node and the identified one or more history nodes.

In some embodiments, for each active node, each history edge node has at least a first role node and a second role node associated therewith. The first role node defines a relationship between the corresponding history edge node and one history node, whereas the second role node defines a relationship between the corresponding history edge node and one of a group consisting of another history node and the corresponding active node.

In some embodiments, upon the identification of the first active node based on the first stimulus, the processing circuitry is further configured to traverse a first set of history edge nodes associated with the first active node to identify the one or more history nodes required for the stimulus processing.

In some embodiments, for each active node, each history edge node of the set of history edge nodes is further coupled to one or more remaining history edge nodes of the set of history edge nodes by way of at least a third role node and a fourth role node. The third role node defines how the one or more remaining history edge nodes are related to the corresponding history edge node. Further, the fourth role node defines how the corresponding history edge node is related to the one or more remaining history edge nodes. The processing circuitry traverses the first set of history edge nodes associated with the first active node based on the coupling therebetween.

In some embodiments, prior to the execution of the operation associated with the first stimulus, the processing circuitry is further configured to load, in the executable graph-based model, at least one of a group consisting of (i) the first active node, (ii) the one or more history nodes and the one or more history edge nodes, associated with the first active node, that are to be utilized for the stimulus processing, and (iii) the first set of history overlay nodes, with corresponding data and processing logic.

In some embodiments, to execute the operation associated with the first stimulus, the processing circuitry is further configured to create, based on the first set of history overlay nodes being associated with the first active node, a cloned first active node that corresponds to a clone of a current version of the first active node. The processing circuitry is further configured to transfer the first set of history overlay nodes to the cloned first active node. The transfer of the first set of history overlay nodes to the cloned first active node results in conversion of the current version of the first active node into a history node. Additionally, the execution of the operation associated with the first stimulus corresponds to a mutation of the cloned first active node based on the one or more history nodes identified for the stimulus processing.

In some embodiments, each of the first active node and the cloned first active node corresponds to a data node. The mutation of the cloned first active node corresponds to modification of data associated with the data node.

In some embodiments, each of the first active node and the cloned first active node comprises a data node and a non-history overlay node. A first history overlay node of the first set of history overlay nodes corresponds to an overlay of the data node and a second history overlay node of the first set of history overlay nodes corresponds to an overlay of the non-history overlay node. Additionally, the mutation of the cloned first active node corresponds to at least one of a group consisting of (i) modification of data associated with the data node, (ii) modification of data associated with the non-history overlay node, and (iii) modification of processing logic associated with the non-history overlay node.

In some embodiments, the non-history overlay node corresponds to at least one of a group consisting of (i) a message handler overlay node, (ii) a message publisher overlay node, (iii) an encryption overlay node, (iv) an audit overlay node, and (v) an obfuscation overlay node.

In some embodiments, each of the first active node and the cloned first active node comprises a node template and a node instance. The node template corresponds to a predefined node structure, whereas the node instance corresponds to an implementation of the node template. A first history overlay node of the first set of history overlay nodes corresponds to an overlay of the node template and a second history overlay node of the first set of history overlay nodes corresponds to an overlay of the node instance. Additionally, the mutation of the cloned first active node corresponds to one of a group consisting of (i) modification of the node template and (ii) modification of the node instance.

In some embodiments, the processing circuitry is further configured to generate the first set of history nodes of the first active node based on a set of stimuli that is received prior to the first stimulus. Further, each history node of the first set of history nodes is a version of the first active node at an instance when the corresponding stimulus is received.

In some embodiments, each stimulus of the set of stimuli corresponds to a command.

In some embodiments, the first set of history nodes associated with the first active node comprises a first history node that corresponds to a first active version of the first active node. Additionally, to generate the first history node, the processing circuitry is further configured to receive a second stimulus of the set of stimuli. When the second stimulus is received, the first set of history overlay nodes is associated with the first active version of the first active node. The processing circuitry is further configured to create a clone of the first active version of the first active node based on the second stimulus. Further, the processing circuitry is configured to transfer the first set of history overlay nodes to the clone of the first active version of the first active node, where the transfer of the first set of history overlay nodes to the clone of the first active version of the first active node results in conversion of the first active version of the first active node into the first history node. The clone of the first active version of the first active node with the first set of history overlay nodes corresponds to a second active version of the first active node. The processing circuitry is further configured to execute an operation associated with the second stimulus on the second active version of the first active node.

In some embodiments, the executable graph-based model further comprises a first history edge node that couples the first history node and the second active version of the first active node and defines a relationship therebetween.

In some embodiments, the second active version of the first active node corresponds to a version of the first active node utilized for executing the operation associated with the first stimulus.

In some embodiments, the first set of history nodes associated with the first active node further comprises a second history node that corresponds to the second active version of the first active node. To generate the second history node, the processing circuitry is further configured to receive a third stimulus of the set of stimuli such that the third stimulus is received before the first stimulus and after the second stimulus. Additionally, when the third stimulus is received, the first set of history overlay nodes is associated with the second active version of the first active node. Further, the processing circuitry is configured to create a clone of the second active version of the first active node based on the third stimulus and transfer the first set of history overlay nodes to the clone of the second active version of the first active node. The transfer of the first set of history overlay nodes to the clone of the second active version of the first active node results in conversion of the second active version of the first active node into the second history node. Further, the clone of the second active version of the first active node with the first set of history overlay nodes corresponds to a third active version of the first active node. The processing circuitry is further configured to execute an operation associated with the third stimulus on the third active version of the first active node.

In some embodiments, the executable graph-based model further comprises (i) a first history edge node that couples the first history node and the second history node and defines a relationship therebetween, and (ii) a second history edge node that couples the second history node and the third active version of the first active node and defines a relationship therebetween. The first history edge node and the second history edge node are coupled to each other by way of two or more role nodes, with each role node defining a relationship therebetween.

In some embodiments, the third active version of the first active node corresponds to a version of the first active node utilized for executing the operation associated with the first stimulus.

In some embodiments, the set of history overlay nodes of each active node indicates a version number and a history depth associated with the corresponding active node. The history depth indicates a maximum number of history nodes associated with each active node. Additionally, the processing circuitry is further configured to delete, from the overlay system, at least one history node associated with each active node based on the version number of the corresponding active node being greater than the history depth of the corresponding active node.

In some embodiments, the set of history overlay nodes of each active node indicates a history retention period associated with the corresponding active node. The history retention period indicates a maximum time duration for which each history node is retained in the overlay system. Additionally, the processing circuitry is further configured to delete at least one history node from the overlay system based on a lapse of a corresponding history retention period.

In some embodiments, each history node of the plurality of history nodes is indicative of a timestamp at which the corresponding history node is created. Additionally, the processing circuitry is further configured to create a plurality of previous versions of the executable graph-based model based on the timestamp associated with each history node of the plurality of history nodes.

In some embodiments, for each active node, an identifier thereof and an identifier of each associated history node are identical, whereas a version number thereof and a version number of each associated history node are different.

In some embodiments, each active node is mutable, and the set of history nodes associated with each active node is immutable.

A person of ordinary skill in the art will appreciate that embodiments and exemplary scenarios of the disclosed subject matter may be practiced with various computer system configurations, including multi-core multiprocessor systems, minicomputers, mainframe computers, computers linked or clustered with distributed functions, as well as pervasive or miniature computers that may be embedded into virtually any device. Further, the operations may be described as a sequential process, however, some of the operations may be performed in parallel, concurrently, and/or in a distributed environment, and with program code stored locally or remotely for access by single or multiprocessor machines. In addition, in some embodiments, the order of operations may be rearranged without departing from the spirit of the disclosed subject matter.

Techniques consistent with the present disclosure provide, among other features, systems and methods for facilitating in-situ history in executable graph-based models. While various embodiments of the disclosed systems and methods have been described above, it should be understood that they have been presented for purposes of example only, and not limitations. It is not exhaustive and does not limit the present disclosure to the precise form disclosed. Modifications and variations are possible in light of the above teachings or may be acquired from practicing the present disclosure, without departing from the breadth or scope.

Moreover, for example, the present technology/system may achieve the following configurations:

1. An overlay system, comprising:
a storage element configured to store an executable graph-based model that comprises a plurality of history nodes, a plurality of active nodes, and a plurality of history overlay nodes, wherein each active node, of the plurality of active nodes, is associated with (i) a set of history nodes of the plurality of history nodes, where the set of history nodes corresponds to a set of historical versions of the corresponding active node, and (ii) a set of history overlay nodes, of the plurality of history overlay nodes, that is configured to facilitate generation and maintenance of the set of history nodes associated with the corresponding active node; and
processing circuitry that is coupled to the storage element, and configured to: receive a first stimulus associated with the overlay system;
identify, in the executable graph-based model for stimulus processing, based on a first context of the first stimulus, (i) a first active node of the plurality of active nodes and (ii) one or more history nodes of a first set of history nodes associated with the first active node; and
execute an operation associated with the first stimulus based on (i) the first active node, (ii) a first set of history overlay nodes, of the plurality of history overlay nodes, associated with the first active node, and (iii) the identified one or more history nodes.

2. The overlay system of 1, wherein the first stimulus corresponds to one of a group consisting of a query and a command.

3. The overlay system of 1,
wherein the executable graph-based model further comprises a plurality of history edge nodes,
wherein each active node is further associated with a set of history edge nodes, of the plurality of history edge nodes, such that each history edge node couples one history node to one of a group consisting of another history node and the corresponding active node, and is indicative of an association therebetween, and
wherein the processing circuitry further executes the operation associated with the first stimulus based on one or more history edge nodes associated with the first active node and the identified one or more history nodes.

4. The overlay system of 3, wherein for each active node, each history edge node has at least a first role node and a second role node associated therewith, where the first role node defines a relationship between the corresponding history edge node and one history node, whereas the second role node defines a relationship between the corresponding history edge node and one of a group consisting of another history node and the corresponding active node.

5. The overlay system of 3, wherein upon the identification of the first active node based on the first stimulus, the processing circuitry is further configured to traverse a first set of history edge nodes associated with the first active node to identify the one or more history nodes required for the stimulus processing.

6. The overlay system of 5, wherein for each active node, each history edge node of the set of history edge nodes is further coupled to one or more remaining history edge nodes of the set of history edge nodes by way of at least a third role node and a fourth role node, where the third role node defines how the one or more remaining history edge nodes are related to the corresponding history edge node, whereas, the fourth role node defines how the corresponding history edge node is related to the one or more remaining history edge nodes, and wherein the processing circuitry traverses the first set of history edge nodes associated with the first active node based on the coupling therebetween.

7. The overlay system of 3, wherein prior to the execution of the operation associated with the first stimulus, the processing circuitry is further configured to load, in the executable graph-based model, at least one of a group consisting of (i) the first active node, (ii) the one or more history nodes and the one or more history edge nodes, associated with the first active node, that are to be utilized for the stimulus processing, and (iii) the first set of history overlay nodes, with corresponding data and processing logic.

8. The overlay system of 1,
wherein to execute the operation associated with the first stimulus, the processing circuitry is further configured to (i) create, based on the first set of history overlay nodes being associated with the first active node, a cloned first active node that corresponds to a clone of a current version of the first active node, and (ii) transfer the first set of history overlay nodes to the cloned first active node, where the transfer of the first set of history overlay nodes to the cloned first active node results in conversion of the current version of the first active node into a history node, and
wherein the execution of the operation associated with the first stimulus corresponds to a mutation of the cloned first active node based on the one or more history nodes identified for the stimulus processing.

9. The overlay system of 8, wherein each of the first active node and the cloned first active node corresponds to a data node, and wherein the mutation of the cloned first active node corresponds to modification of data associated with the data node.

10. The overlay system of 8,
wherein each of the first active node and the cloned first active node comprises a data node and a non-history overlay node,
wherein a first history overlay node of the first set of history overlay nodes corresponds to an overlay of the data node and a second history overlay node of the first set of history overlay nodes corresponds to an overlay of the non-history overlay node, and
wherein the mutation of the cloned first active node corresponds to at least one of a group consisting of (i) modification of data associated with the data node, (ii) modification of data associated with the non-history overlay node, and (iii) modification of processing logic associated with the non-history overlay node.

11. The overlay system of 10, wherein the non-history overlay node corresponds to at least one of a group consisting of (i) a message handler overlay node, (ii) a message publisher overlay node, (iii) an encryption overlay node, (iv) an audit overlay node, and (v) an obfuscation overlay node.

12. The overlay system of 8,
wherein each of the first active node and the cloned first active node comprises a node template and a node instance,
wherein the node template corresponds to a predefined node structure, whereas the node instance corresponds to an implementation of the node template,
wherein a first history overlay node of the first set of history overlay nodes corresponds to an overlay of the node template and a second history overlay node of the first set of history overlay nodes corresponds to an overlay of the node instance, and
wherein the mutation of the cloned first active node corresponds to one of a group consisting of (i) modification of the node template and (ii) modification of the node instance.

13. The overlay system of 1, wherein the processing circuitry is further configured to generate the first set of history nodes of the first active node based on a set of stimuli that is received prior to the first stimulus, and wherein each history node of the first set of history nodes is a version of the first active node at an instance when the corresponding stimulus is received.

14. The overlay system of 13, wherein each stimulus of the set of stimuli corresponds to a command.

15. The overlay system of 13, wherein the first set of history nodes associated with the first active node comprises a first history node that corresponds to a first active version of the first active node, and to generate the first history node, the processing circuitry is further configured to:
receive a second stimulus of the set of stimuli, wherein when the second stimulus is received, the first set of history overlay nodes is associated with the first active version of the first active node;
create a clone of the first active version of the first active node based on the second stimulus;
transfer the first set of history overlay nodes to the clone of the first active version of the first active node, where the transfer of the first set of history overlay nodes to the clone of the first active version of the first active node results in conversion of the first active version of the first active node into the first history node, wherein the clone of the first active version of the first active node with the first set of history overlay nodes corresponds to a second active version of the first active node; and
execute an operation associated with the second stimulus on the second active version of the first active node.

16. The overlay system of 15, wherein the executable graph-based model further comprises a first history edge node that couples the first history node and the second active version of the first active node and defines a relationship therebetween.

17. The overlay system of 15, wherein the second active version of the first active node corresponds to a version of the first active node utilized for executing the operation associated with the first stimulus.

18. The overlay system of 15, wherein the first set of history nodes associated with the first active node further comprises a second history node that corresponds to the second active version of the first active node, and to generate the second history node, the processing circuitry is further configured to:
receive a third stimulus of the set of stimuli, wherein the third stimulus is received before the first stimulus and after the second stimulus, and wherein when the third stimulus is received, the first set of history overlay nodes is associated with the second active version of the first active node;
create a clone of the second active version of the first active node based on the third stimulus;
transfer the first set of history overlay nodes to the clone of the second active version of the first active node, where the transfer of the first set of history overlay nodes to the clone of the second active version of the first active node results in conversion of the second active version of the first active node into the second history node, wherein the clone of the second active version of the first active node with the first set of history overlay nodes corresponds to a third active version of the first active node; and
execute an operation associated with the third stimulus on the third active version of the first active node.

19. The overlay system of 18, wherein the executable graph-based model further comprises (i) a first history edge node that couples the first history node and the second history node and defines a relationship therebetween, and (ii) a second history edge node that couples the second history node and the third active version of the first active node and defines a relationship therebetween, and wherein the first history edge node and the second history edge node are coupled to each other by way of two or more role nodes, with each role node defining a relationship therebetween.

20. The overlay system of 18, wherein the third active version of the first active node corresponds to a version of the first active node utilized for executing the operation associated with the first stimulus.

21. The overlay system of 1, wherein the set of history overlay nodes of each active node indicates a version number and a history depth associated with the corresponding active node, wherein the history depth indicates a maximum number of history nodes associated with each active node, and wherein the processing circuitry is further configured to delete, from the overlay system, at least one history node associated with each active node based on the version number of the corresponding active node being greater than the history depth of the corresponding active node.

22. The overlay system of 1, wherein the set of history overlay nodes of each active node indicates a history retention period associated with the corresponding active node, wherein the history retention period indicates a maximum time duration for which each history node is retained in the overlay system, and wherein the processing circuitry is further configured to delete at least one history node from the overlay system based on a lapse of a corresponding history retention period.

23. The overlay system of 1, wherein each history node of the plurality of history nodes is indicative of a timestamp at which the corresponding history node is created, and wherein the processing circuitry is further configured to create a plurality of previous versions of the executable graph-based model based on the timestamp associated with each history node of the plurality of history nodes.

24. The overlay system of 1, wherein for each active node, an identifier thereof and an identifier of each associated history node are identical, whereas a version number thereof and a version number of each associated history node are different.

25. The overlay system of 1, wherein each active node is mutable, and the set of history nodes associated with each active node is immutable.

26. A method, comprising:
receiving, by processing circuitry of an overlay system, a first stimulus associated with the overlay system, wherein an executable graph-based model is stored in a storage element of the overlay system, wherein the executable graph-based model comprises a plurality of history nodes, a plurality of active nodes, and a plurality of history overlay nodes, and wherein each active node, of the plurality of active nodes, is associated with (i) a set of history nodes of the plurality of history nodes, where the set of history nodes corresponds to a set of historical versions of the corresponding active node, and (ii) a set of history overlay nodes, of the plurality of history overlay nodes, where generation and maintenance of the set of history nodes associated with the corresponding active node is facilitated by the set of history overlay nodes;
identifying, in the executable graph-based model for stimulus processing, based on a first context of the first stimulus, (i) a first active node of the plurality of active nodes and (ii) one or more history nodes of a first set of history nodes associated with the first active node; and
executing, by the processing circuitry, an operation associated with the first stimulus based on (i) the first active node, (ii) a first set of history overlay nodes, of the plurality of history overlay nodes, associated with the first active node, and (iii) the identified one or more history nodes.

What is claimed is:

1. An overlay system, comprising:
a storage element configured to store an executable graph-based model that comprises a plurality of history nodes, a plurality of active nodes, and a plurality of history overlay nodes, wherein each active node, of the plurality of active nodes, is associated with (i) a set of history nodes of the plurality of history nodes, where the set of history nodes corresponds to a set of historical versions of the corresponding active node, and (ii) a set of history overlay nodes, of the plurality of history overlay nodes, that is configured to facilitate generation and maintenance of the set of history nodes associated with the corresponding active node; and
processing circuitry that is coupled to the storage element, and configured to:
receive a first stimulus associated with the overlay system;
identify, in the executable graph-based model for stimulus processing, based on a first context of the first stimulus, (i) a first active node of the plurality of active nodes and (ii) one or more history nodes of a first set of history nodes associated with the first active node; and
execute an operation associated with the first stimulus based on (i) the first active node, (ii) a first set of history overlay nodes, of the plurality of history overlay nodes, associated with the first active node, and (iii) the identified one or more history nodes.

2. The overlay system of claim 1, wherein the first stimulus corresponds to one of a group consisting of a query and a command.

3. The overlay system of claim 1,
wherein the executable graph-based model further comprises a plurality of history edge nodes,
wherein each active node is further associated with a set of history edge nodes, of the plurality of history edge nodes, such that each history edge node couples one history node to one of a group consisting of another history node and the corresponding active node, and is indicative of an association therebetween, and
wherein the processing circuitry further executes the operation associated with the first stimulus based on one or more history edge nodes associated with the first active node and the identified one or more history nodes.

4. The overlay system of claim 3, wherein for each active node, each history edge node has at least a first role node and a second role node associated therewith, where the first role node defines a relationship between the corresponding history edge node and one history node, whereas the second role node defines a relationship between the corresponding history edge node and one of a group consisting of another history node and the corresponding active node.

5. The overlay system of claim 3, wherein upon the identification of the first active node based on the first stimulus, the processing circuitry is further configured to traverse a first set of history edge nodes associated with the first active node to identify the one or more history nodes required for the stimulus processing.

6. The overlay system of claim 5, wherein for each active node, each history edge node of the set of history edge nodes is further coupled to one or more remaining history edge nodes of the set of history edge nodes by way of at least a third role node and a fourth role node, where the third role node defines how the one or more remaining history edge nodes are related to the corresponding history edge node, whereas, the fourth role node defines how the corresponding history edge node is related to the one or more remaining history edge nodes, and wherein the processing circuitry traverses the first set of history edge nodes associated with the first active node based on the coupling therebetween.

7. The overlay system of claim 3, wherein prior to the execution of the operation associated with the first stimulus, the processing circuitry is further configured to load, in the executable graph-based model, at least one of a group consisting of (i) the first active node, (ii) the one or more history nodes and the one or more history edge nodes, associated with the first active node, that are to be utilized for the stimulus processing, and (iii) the first set of history overlay nodes, with corresponding data and processing logic.

8. The overlay system of claim 1,
wherein to execute the operation associated with the first stimulus, the processing circuitry is further configured to (i) create, based on the first set of history overlay nodes being associated with the first active node, a cloned first active node that corresponds to a clone of a current version of the first active node, and (ii) transfer the first set of history overlay nodes to the cloned first active node, where the transfer of the first set of history overlay nodes to the cloned first active node results in conversion of the current version of the first active node into a history node, and
wherein the execution of the operation associated with the first stimulus corresponds to a mutation of the cloned first active node based on the one or more history nodes identified for the stimulus processing.

9. The overlay system of claim 8, wherein each of the first active node and the cloned first active node corresponds to a data node, and wherein the mutation of the cloned first active node corresponds to modification of data associated with the data node.

10. The overlay system of claim 8,
wherein each of the first active node and the cloned first active node comprises a data node and a non-history overlay node,
wherein a first history overlay node of the first set of history overlay nodes corresponds to an overlay of the data node and a second history overlay node of the first set of history overlay nodes corresponds to an overlay of the non-history overlay node, and
wherein the mutation of the cloned first active node corresponds to at least one of a group consisting of (i) modification of data associated with the data node, (ii) modification of data associated with the non-history overlay node, and (iii) modification of processing logic associated with the non-history overlay node.

11. The overlay system of claim 10, wherein the non-history overlay node corresponds to at least one of a group consisting of (i) a message handler overlay node, (ii) a message publisher overlay node, (iii) an encryption overlay node, (iv) an audit overlay node, and (v) an obfuscation overlay node.

12. The overlay system of claim 8,
wherein each of the first active node and the cloned first active node comprises a node template and a node instance,
wherein the node template corresponds to a predefined node structure, whereas the node instance corresponds to an implementation of the node template,
wherein a first history overlay node of the first set of history overlay nodes corresponds to an overlay of the node template and a second history overlay node of the first set of history overlay nodes corresponds to an overlay of the node instance, and
wherein the mutation of the cloned first active node corresponds to one of a group consisting of (i) modification of the node template and (ii) modification of the node instance.

13. The overlay system of claim 1, wherein the processing circuitry is further configured to generate the first set of history nodes of the first active node based on a set of stimuli that is received prior to the first stimulus, and wherein each history node of the first set of history nodes is a version of the first active node at an instance when the corresponding stimulus is received.

14. The overlay system of claim 13, wherein each stimulus of the set of stimuli corresponds to a command.

15. The overlay system of claim 13, wherein the first set of history nodes associated with the first active node comprises a first history node that corresponds to a first active version of the first active node, and to generate the first history node, the processing circuitry is further configured to:
receive a second stimulus of the set of stimuli, wherein when the second stimulus is received, the first set of history overlay nodes is associated with the first active version of the first active node;
create a clone of the first active version of the first active node based on the second stimulus;
transfer the first set of history overlay nodes to the clone of the first active version of the first active node, where the transfer of the first set of history overlay nodes to the clone of the first active version of the first active node results in conversion of the first active version of the first active node into the first history node, wherein the clone of the first active version of the first active node with the first set of history overlay nodes corresponds to a second active version of the first active node; and
execute an operation associated with the second stimulus on the second active version of the first active node.

16. The overlay system of claim 15, wherein the executable graph-based model further comprises a first history edge node that couples the first history node and the second active version of the first active node and defines a relationship therebetween.

17. The overlay system of claim 15, wherein the second active version of the first active node corresponds to a version of the first active node utilized for executing the operation associated with the first stimulus.

18. The overlay system of claim 15, wherein the first set of history nodes associated with the first active node further comprises a second history node that corresponds to the second active version of the first active node, and to generate the second history node, the processing circuitry is further configured to:
receive a third stimulus of the set of stimuli, wherein the third stimulus is received before the first stimulus and after the second stimulus, and wherein when the third stimulus is received, the first set of history overlay nodes is associated with the second active version of the first active node;
create a clone of the second active version of the first active node based on the third stimulus;
transfer the first set of history overlay nodes to the clone of the second active version of the first active node, where the transfer of the first set of history overlay nodes to the clone of the second active version of the first active node results in conversion of the second active version of the first active node into the second history node, wherein the clone of the second active version of the first active node with the first set of history overlay nodes corresponds to a third active version of the first active node; and
execute an operation associated with the third stimulus on the third active version of the first active node.

19. The overlay system of claim 18, wherein the executable graph-based model further comprises (i) a first history edge node that couples the first history node and the second history node and defines a relationship therebetween, and (ii) a second history edge node that couples the second history node and the third active version of the first active node and defines a relationship therebetween, and wherein the first history edge node and the second history edge node are coupled to each other by way of two or more role nodes, with each role node defining a relationship therebetween.

20. The overlay system of claim 18, wherein the third active version of the first active node corresponds to a version of the first active node utilized for executing the operation associated with the first stimulus.
